(19) United States
(12) Patent Application Publication
(10) Pub. No.: US 2024/0393937 A1
(43) Pub. Date: Nov. 28, 2024

(54) METHOD FOR PLAYING BACK MULTIMEDIA RESOURCE AND TERMINAL

(71) Applicant: BEIJING DAJIA INTERNET INFORMATION TECHNOLOGY CO., LTD., Beijing (CN)

(72) Inventors: Zhen CHEN, Beijing (CN); Tianshu LI, Beijing (CN); Ximeng LU, Beijing (CN); Ge SONG, Beijing (CN)

(21) Appl. No.: 18/593,076

(22) Filed: Mar. 1, 2024

(30) Foreign Application Priority Data
May 22, 2023 (CN) 202310574119.9

(51) Int. Cl. G06F 3/04855; G06F 3/01; G06F 3/0481; G06F 3/0488

(52) U.S. Cl. CPC G06F 3/04855; G06F 3/016; G06F 3/0481; G06F 3/0488

(57) ABSTRACT

Provided is a method for playing back a multimedia resource. The method includes: playing back the multimedia resource on a playback interface; playing back the multimedia resource in a multi-speed mode in response to a first multi-speed set operation on the playback interface, wherein the multi-speed mode corresponds to a reference playback multi-speed; and continuously playing back, in response to a progress adjust operation on the playback interface, the multimedia resource in the multi-speed mode using a playback progress corresponding to the progress adjust operation as a playback start point.

### CROSS-REFERENCE TO RELATED APPLICATION

This application is based on and claims priority to Chinese Patent Application No. 202310574119.9, filed on May 22, 2023, the disclosure of which is herein incorporated by reference in its entirety.

### TECHNICAL FIELD

The present disclosure relates to the field of multimedia technologies, and in particular, relates to a method for playing back a multimedia resource and a terminal.

### BACKGROUND

With developments of the multimedia technologies, terminals provide more and more functions with respect to playback of multimedia resources thereon. For example, a multi-speed function can be used for multi-speed playback of the multimedia resource. With users' increasing demands on functions in playback of the multimedia resource, it is important and challenge to provide more functions to the playback of the multimedia resource.

### SUMMARY

Embodiments of the present disclosure provide a method for playing back a multimedia resource and a terminal.

According to some embodiments of the present disclosure, a method for playing back a multimedia resource is provided.

The method includes: playing back the multimedia resource on a playback interface; playing back the multimedia resource in a multi-speed mode in response to a first multi-speed set operation on the playback interface, wherein the multi-speed mode corresponds to a reference playback multi-speed; and continuously playing back, in response to a progress adjust operation on the playback interface, the multimedia resource in the multi-speed mode using a playback progress corresponding to the progress adjust operation as a playback start point.

According to some embodiments of the present disclosure, a terminal is provided. The terminal includes one or more processors, and a memory storing one or more instructions executable by the one or more processors; wherein the one or more processors, when loading and executing the one or more instructions, are caused to: play back the multimedia resource on a playback interface; play back the multimedia resource in a multi-speed mode in response to a first multi-speed set operation on the playback interface, wherein the multi-speed mode corresponds to a reference playback multi-speed; and continuously play back, in response to a progress adjust operation on the playback interface, the multimedia resource in the multi-speed mode using a playback progress corresponding to the progress adjust operation as a playback start point.

According to some embodiments of the present disclosure, a computer-readable storage medium storing one or more instructions therein is provided. The one or more instructions, when loaded and executed by a processor in a terminal, cause the terminal to: play back the multimedia resource on a playback interface; play back the multimedia resource in a multi-speed mode in response to a first multi-speed set operation on the playback interface, wherein the multi-speed mode corresponds to a reference playback multi-speed; and continuously play back, in response to a progress adjust operation on the playback interface, the multimedia resource in the multi-speed mode using a playback progress corresponding to the progress adjust operation as a playback start point.

### BRIEF DESCRIPTION OF DRAWINGS

FIG. 1 is a schematic diagram of an application environment according to some embodiments of the present disclosure;

FIG. 2 is a flowchart of a method for playing back a multimedia resource according to some embodiments of the present disclosure;

FIG. 3 is a flowchart of another method for playing back a multimedia resource according to some embodiments of the present disclosure;

FIG. 4 is a schematic diagram of a playback interface displaying first prompt information according to some embodiments of the present disclosure;

FIG. 5 is a schematic diagram of a playback interface displaying prompt information of a multi-speed mode according to some embodiments of the present disclosure;

FIG. 6 is a flowchart of another method for playing back a multimedia resource according to some embodiments of the present disclosure;

FIG. 7 is a schematic diagram of a playback interface displaying second prompt information according to some embodiments of the present disclosure;

FIG. 8 is a flowchart of another method for playing back a multimedia resource according to some embodiments of the present disclosure;

FIG. 9 is a schematic diagram of a playback interface displaying fourth prompt information according to some embodiments of the present disclosure;

FIG. 10 is a schematic diagram of a playback interface of adjusting a playback multi-speed according to some embodiments of the present disclosure;

FIG. 11 is a schematic diagram of another playback interface of adjusting a playback multi-speed according to some embodiments of the present disclosure;

FIG. 12 is a schematic diagram of a playback interface displaying a multi-speed progress bar according to some embodiments of the present disclosure;

FIG. 13 is a schematic diagram of another playback interface of adjusting a playback multi-speed according to some embodiments of the present disclosure;

FIG. 14 is a block diagram of an apparatus for playing back a multimedia resource according to some embodiments of the present disclosure; and

FIG. 15 is a block diagram of a terminal according to some embodiments of the present disclosure.

### DETAILED DESCRIPTION

It should be noted that the information (including but not limited to information of a user device, personal information of a user, and the like), data (including but not limited to data for analyzing, data for storing, data for displaying, and the like), and signals involved in the present disclosure are authorized by the user or sufficiently authorized by the parties, and acquisition, using, and processing of the relevant require to comply with relevant laws, regulations and standards of the relevant countries and regions. For example, the multimedia resources in the present disclosure are acquired and sufficiently authorized.

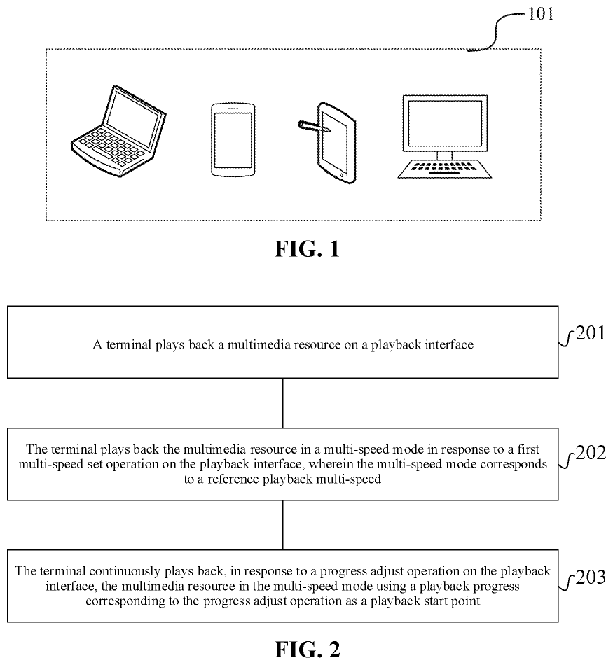

The method for playing back the multimedia resource in the embodiments of the present disclosure is performed by a terminal. FIG. 1 is a schematic diagram of an application environment according to some embodiments of the present disclosure. Referring to FIG. 1, the application environment includes a terminal 101. In the embodiments of the present disclosure, a target application is installed in the terminal 101, and the target application is an application for playing back the multimedia resource. The target application provides a multi-speed function, a progress adjust function, and the like. The terminal plays back the multimedia resource in a multi-speed mode based on the multi-speed function, and adjusts a playback progress of the multimedia resource based on the progress adjust function. The multimedia resource is an image, an audio, a video, and the like. The embodiments of the present disclosure are described by taking the multimedia resource being a video as an example.

The terminal 101 is at least one of devices such as a smartphone, a smartwatch, a desktop computer, a laptop, a virtual reality terminal, an augmented reality terminal, a wireless terminal, a laptop computer, and the like. The terminal 101 has a communication function, and is capable of accessing a wire network or a wireless network. The terminal 101 refers to one of a plurality of terminals, and those skilled in the art know that the number of terminals is not limited herein.

FIG. 2 is a flowchart of a method for playing back a multimedia resource according to some embodiments of the present disclosure. As shown in FIG. 2, the method is performed by a terminal and includes the following processes.

In S201, the terminal plays back a multimedia resource on a playback interface.

In some embodiments, the target application is installed in the terminal, the playback interface is an interface of the target application, and the target application can play back the multimedia resource. Correspondingly, the target application is a short video application, a video application, a shopping application. or a social application capable of playing back the multimedia resource, and the like. In some embodiments, the playback interface is an interface of a player of the terminal, which is not limited herein.

In S202, the terminal plays back the multimedia resource in a multi-speed mode in response to a first multi-speed set operation on the playback interface, wherein the multi-speed mode corresponds to a reference playback multi-speed.

In some embodiments of the present disclosure, the first multi-speed set operation is set and changed according to actual needs. The first multi-speed set operation may be an operation performed on any region of the playback interface, or on a reference region of the playback interface. For example, the first multi-speed set operation is a long-press operation or a double-tap operation on the playback interface. The embodiments of the present disclosure are described by taking the first multi-speed set operation being the long-press operation as an example. In one example, the terminal is configured to cause the fast playback in response to the long-press operation on the sides of the screen of the terminal. The side of the screen may be an edge portion of the screen.

In the embodiments of the present disclosure, the reference playback multi-speed is preset, and is a playback multi-speed other than 1× speed, and is set and changed to other scales according to actual needs, for example, 1.5× speed, 2× speed, and the like.

In S203, the terminal continuously plays back, in response to a progress adjust operation on the playback interface, the multimedia resource in the multi-speed mode, wherein a playback progress corresponding to the progress adjust operation is used as a playback start point.

In the embodiments of the present disclosure, the progress adjust operation is set and changed according to actual needs. For example, the progress adjust operation is a swipe operation, a trigger operation, and the like. The swipe operation and the trigger operation may be performed on a region on the playback interface or performed on a playback progress bar displayed on the playback interface. In some embodiments of the present disclosure, a swipe operation is as an example of the progress adjust operation. Correspondingly, the playback progress corresponding to the progress adjust operation is a playback progress corresponding to a swipe amplitude of the swipe operation.

The terminal adjusts the playback progress of the multimedia resource in response to the progress adjust operation on the playback interface, and continuously plays back the multimedia resource in the multi-speed mode using the playback progress corresponding to the progress adjust operation as the playback start point upon an end of the progress adjust operation.

Embodiments of the present disclosure provide a method for playing back a multimedia resource. In the method, in the case that the multimedia resource is played back in the multi-speed mode, the multimedia resource is continuously played back in the multi-speed mode after the playback progress is adjusted by a user via a progress adjust operation on the playback interface. As such, the multimedia resource is continuously played back in the multi-speed mode without the need to trigger the multi-speed mode again. In some embodiment, the terminal is configured to detect the playback speed when the playback progress is adjusted, and in the case that the multi-speed mode is detected, continuously playback in a multi-speed until the cancellation of the multi-speed mode. In this way, the multi-speed function and the progress adjust function are combined to a new function, the diversity of the interaction is increased, and the interaction efficiency is improved.

In some embodiments, the progress adjust operation is a swipe operation to a first direction or a swipe operation to a second direction on the playback interface. The swipe operation to the first direction and the swipe operation to the second direction correspond to different adjust directions of the playback progress.

In the embodiments of the present disclosure, the progress adjust operation is set as the swipe operation to the first direction or the swipe operation to the second direction, and the swipe operation to the first direction and the swipe operation to the second direction correspond to different adjust directions of the playback progress, such that adjustments of the playback progress in different directions are achieved by the swipe operations to different directions, and the flexibility of the adjustments of the playback progress is further improved.

In some embodiments, a playback progress bar of the multimedia resource is displayed on the playback interface. Prior to playing back the multimedia resource in the multi-speed mode in response to the first multi-speed set operation on the playback interface, the method further includes: displaying first prompt information on the playback interface in response to a drag operation on the playback progress bar, wherein the first prompt information is configured to prompt the first multi-speed set operation on the playback interface to enter the multi-speed mode; or displaying first prompt information on the playback interface in response to a drag operation on the playback progress bar and a cumulative use duration of an object in using an application not reaching a first reference duration, wherein the playback interface is an interface in the application, and not displaying the first prompt information on the playback interface in response to the drag operation on the playback progress bar and the cumulative use duration reaching the first reference duration; or displaying first prompt information on the playback interface in response to a drag operation on the playback progress bar and a number of times of entering the multi-speed mode based on the first multi-speed set operation on the playback interface not reaching a first reference number, and not displaying the first prompt information on the playback interface in response to the drag operation on the playback progress bar and the number of the times of entering the multi-speed mode based on the first multi-speed set operation on the playback interface reaching the first reference number; or displaying first prompt information on the playback interface in response to a drag operation on the playback progress bar, and not displaying the first prompt information in response to a display duration of the first prompt information reaching a second reference duration.

In the embodiments of the present disclosure, in adjusting the playback progress based on the playback progress bar, the prompt information on how to enter the multi-speed mode is displayed, such that the prompt information of the multi-speed function is fully output by the interrelation of the progress adjust function and the multi-speed function, the user has knowledge of the multi-speed function, and the utilization of the multi-speed function is improved. The first prompt information is displayed in the case that the cumulative use duration is small, and the first prompt information is not displayed in the case that the cumulative use duration is large. That is, the first prompt information is displayed in the case that the user is not accustomed to the application, such that the user is capable of getting full knowledge of the function prompted by the first prompt information. In the case that the user uses the application for a period of time and is accustomed to the application, the user has full knowledge of the function prompted by the first prompt information, and thus the first prompt information is not displayed, such that reasonability of display of the first prompt information is improved, and consumption in displaying the resource on the interface is reduced on the premise that the user has knowledge of the prompt information. The first prompt information is displayed in the case that the number of times of using the multi-speed function is small, and the first prompt information is not displayed in the case that the number of times of using the multi-speed function is large. That is, the first prompt information is displayed in the case that the user is not accustomed to the application, such that the user is capable of getting full knowledge of the function prompted by the first prompt information. In the case that the user uses the application for a period of time and is accustomed to the application, the user has full knowledge of the function prompted by the first prompt information, and thus the first prompt information is not displayed, such that the reasonability of display of the first prompt information is improved, and consumption in displaying the resource on the interface is reduced on the premise that the user has knowledge of the prompt information. The first prompt information disappears upon display of the first prompt information for a period of time, such that the prompt function is implemented, consumption in displaying the resource on the interface is reduced, and conciseness of the interface is improved.

In some embodiments, a playback progress bar of the multimedia resource is displayed on the playback interface. Prior to playing back the multimedia resource in the multi-speed mode in response to the first multi-speed set operation on the playback interface, the method further includes: displaying second prompt information on the playback interface in response to a drag operation on the playback progress bar, wherein the second prompt information is configured to prompt a second multi-speed set operation on the playback interface to enter the multi-speed mode; or displaying second prompt information on the playback interface in response to a drag operation on the playback progress bar and a cumulative use duration of an object in using an application not reaching a third reference duration, wherein the playback interface is an interface in the application, and not displaying the second prompt information on the playback interface in response to the drag operation on the playback progress bar and the cumulative use duration reaching the third reference duration; or displaying second prompt information on the playback interface in response to a drag operation on the playback progress bar and a number of times of entering the multi-speed mode based on the second multi-speed set operation on the playback interface not reaching a second reference number, and not displaying the second prompt information on the playback interface in response to the drag operation on the playback progress bar and the number of the times of entering the multi-speed mode based on the second multi-speed set operation on the playback interface reaching the second reference number; or displaying second prompt information on the playback interface in response to a drag operation on the playback progress bar, and not displaying the second prompt information in response to a display duration of the second prompt information reaching a fourth reference duration.

In the embodiments of the present disclosure, in adjusting the playback progress based on the playback progress bar, the prompt information on how to enter the multi-speed mode is displayed, such that the prompt information on the multi-speed function is fully output by the interrelation of the progress adjust function and the multi-speed function, the user has knowledge of the multi-speed function, and the utilization of the multi-speed function is improved. The second prompt information is displayed in the case that the cumulative use duration is small, and the second prompt information is not displayed in the case that the cumulative use duration is large. That is, the second prompt information is displayed in the case that the user is not accustomed to the application, such that the user is capable of getting full knowledge of the function prompted by the second prompt information. In the case that the user uses the application for a period of time and is accustomed to the application, the user has full knowledge of the function prompted by the second prompt information, and thus the second prompt information is not displayed, such that the reasonability of display of the second prompt information is improved, and consumption in displaying the resource on the interface is reduced on the premise that the user has knowledge of the prompt information. The second prompt information is displayed in the case that the number of times of using the multi-speed function is small, and the second prompt information is not displayed in the case that the number of times of using the multi-speed function is large. That is, the second prompt information is displayed in the case that the user is not accustomed to the application, such that the user is capable of getting full knowledge of the function prompted by the second prompt information. In the case that the user uses the application for a period of time and is accustomed to the application, the user has full knowledge of the function prompted by the second prompt information, and thus the second prompt information is not displayed, such that the reasonability of display of the second prompt information is improved, and consumption in displaying the resource on the interface is reduced on the premise that the user has knowledge of the prompt information. The second prompt information disappears upon display of the second prompt information for a period of time, such that the prompt function is implemented, consumption in displaying the resource on the interface is reduced, and conciseness of the interface is improved.

In some embodiments, displaying the second prompt information on the playback interface in response to the drag operation on the playback progress bar includes: displaying a thumbnail of the multimedia resource on the playback interface in response to the drag operation on the playback progress bar, and displaying the second prompt information in an associated region of the thumbnail, wherein the thumbnail corresponds to a multimedia resource screen determined based on the drag operation.

In the embodiments of the present disclosure, the second prompt information is displayed in a nearby region of the thumbnail, such that the second prompt information is more noticeable, the possibility of acquiring the second prompt information by the user is increased, the display effect of the second prompt information is improved, and the user is urged to use the multi-speed function based on the second prompt information.

In some embodiments, the method further includes: playing back the multimedia resource in the multi-speed mode in response to the second multi-speed set operation on the playback interface in performing the drag operation.

In the embodiments of the present disclosure, the terminal plays back the multimedia resource in the multi-speed mode in response to the second multi-speed set operation on the playback interface. That is, the multi-speed mode is entered in adjusting the playback progress by continuous gesture operations of the drag operation and the second multi-speed set operation. In the embodiments, the new interaction gesture is developed, and the rapid interaction manner of entering the multi-speed mode in adjusting the playback progress is achieved by the new interaction gesture, the diversity of the interaction is increased, and the interaction efficiency is improved.

In some embodiments, a playback progress bar of the multimedia resource is displayed on the playback interface, and the method includes at least one of: displaying prompt information of the multi-speed mode in the playback progress bar in the multi-speed mode, wherein the prompt information of the multi-speed mode is configured to prompt current playback of the multimedia resource in the multi-speed mode; and displaying third prompt information on the playback interface in the multi-speed mode, wherein the third prompt information is configured to prompt the progress adjust operation on the playback interface to adjust playback progress of the multimedia resource; or displaying third prompt information on the playback interface in the multi-speed mode in response to a cumulative use duration of an object in using an application not reaching a fifth reference duration, the playback interface being an interface in the application, and not displaying the third prompt information on the playback interface in the multi-speed mode in response to the cumulative use duration reaching the fifth reference duration; or displaying third prompt information on the playback interface in the multi-speed mode in response to a number of times of adjusting the playback progress based on the progress adjust operation not reaching a third reference number, and not displaying the third prompt information on the playback interface in the multi-speed mode in response to the number of the times of adjusting the playback progress based on the progress adjust operation reaching the third reference number; or displaying third prompt information on the playback interface in the multi-speed mode, and not displaying the third prompt information in response to a display duration of the third prompt information reaching a sixth reference duration.

In the embodiments of the present disclosure, the prompt information of the multi-speed mode is displayed in the multi-speed mode, such that the user acquires feedback information of entering the multi-speed mode, the completeness of interaction is improved. In the multi-speed mode, the prompt information on how to adjust the playback progress is displayed, such that the prompt information of the progress adjust function is fully output by the interrelation of the progress adjust function and the multi-speed function, the user has knowledge of the function, and the user is promoted to perform the progress adjust function. That is, the user is urged to use the progress adjust function. The third prompt information is displayed in the case that the cumulative use duration is small, and the third prompt information is not displayed in the case that the cumulative use duration is large. That is, the third prompt information is displayed in the case that the user is not accustomed to the application, such that the user is capable of getting full knowledge of the function prompted by the third prompt information. In the case that the user uses the application for a period of time and is accustomed to the application, the user has full knowledge of the function prompted by the third prompt information, and thus the third prompt information is not displayed, such that the reasonability of display of the third prompt information is improved, and consumption in displaying the resource on the interface is reduced on the premise that the user has knowledge of the prompt information. The third prompt information is displayed in the case that the number of times of using the progress adjust function is small, and the third prompt information is not displayed in the case that the number of times of using the progress adjust function is large. That is, the third prompt information is displayed in the case that the user is not accustomed to the application, such that the user is capable of getting full knowledge of the function prompted by the third prompt information. In the case that the user uses the application for a period of time and is accustomed to the application, the user has full knowledge of the function prompted by the third prompt information, and thus the third prompt information is not displayed, such that the reasonability of display of the third prompt information is improved, and consumption in displaying the resource on the interface is reduced on the premise that the user has knowledge of the prompt information. The third prompt information disappears upon display of the third prompt information for a period of time, such that the prompt function is implemented, consumption in displaying the resource on the interface is reduced, and conciseness of the interface is improved.

In some embodiments, the method further includes: displaying fourth prompt information on the playback interface in the multi-speed mode, wherein the fourth prompt information is configured to prompt a multi-speed adjust operation on the playback interface to adjust playback multi-speed of the multimedia resource; or displaying fourth prompt information on the playback interface in the multi-speed mode in response to a cumulative use duration of an object in using an application not reaching a seventh reference duration, the playback interface being an interface in the application, and not displaying fourth prompt information on the playback interface in the multi-speed mode in response to the cumulative use duration reaching the seventh reference duration; or displaying fourth prompt information on the playback interface in the multi-speed mode in response to a number of times of adjusting the playback multi-speed based on the multi-speed adjust operation not reaching a fourth reference number, and not displaying the fourth prompt information on the playback interface in the multi-speed mode in response to the number of the times of adjusting the playback multi-speed based on the multi-speed adjust operation reaching the fourth reference number; or displaying fourth prompt information on the playback interface in the multi-speed mode, and not displaying the fourth prompt information in response to a display duration of the fourth prompt information reaching an eighth reference duration; and adjusting the playback multi-speed of the multimedia resource in the multi-speed mode in response to the multi-speed adjust operation on the playback interface, and playing back the multimedia resource based on the adjusted playback multi-speed.

In the embodiments of the present disclosure, the terminal randomly adjusts the playback multi-speed of the multimedia resource in the multi-speed mode based on the multi-speed adjust operation on the playback interface, such that the quick adjustment on the playback multi-speed in the multi-speed mode is achieved, the playback multi-speed can be adjusted randomly and repeatedly, the efficiency of adjusting the playback multi-speed is improved, and the efficiency of human-computer interaction is improved. The fourth prompt information is displayed in the case that the cumulative use duration is small, and the fourth prompt information is not displayed in the case that the cumulative use duration is large. That is, the fourth prompt information is displayed in the case that the user is not accustomed to the application, such that the user is capable of getting full knowledge of the function prompted by the fourth prompt information. In the case that the user uses the application for a period of time and is accustomed to the application, the user has full knowledge of the function prompted by the fourth prompt information, and thus the fourth prompt information is not displayed, such that the reasonability of display of the fourth prompt information is improved, and consumption in displaying the resource on the interface is reduced on the premise that the user has knowledge of the prompt information. The fourth prompt information is displayed in the case that the number of times of using the progress adjust function is small, and the fourth prompt information is not displayed in the case that the number of times of using the progress adjust function is large. That is, the fourth prompt information is displayed in the case that the user is not accustomed to the application, such that the user is capable of getting full knowledge of the function prompted by the fourth prompt information. In the case that the user uses the application for a period of time and is accustomed to the application, the user has full acknowledge of the function prompted by the fourth prompt information, and thus the fourth prompt information is not displayed, such that the reasonability of display of the fourth prompt information is improved, and consumption in displaying the resource on the interface is reduced on the premise that the user has knowledge of the prompt information. The fourth prompt information disappears upon display of the fourth prompt information for a period of time, such that the prompt function is implemented, consumption in displaying the resource on the interface is reduced, and conciseness of the interface is improved.

In some embodiments, adjusting the playback multi-speed of the multimedia resource in response to the multi-speed adjust operation on the playback interface includes: determining a playback multi-speed corresponding to a swipe amplitude of a swipe operation in response to the swipe operation on the playback interface, and adjusting the playback multi-speed of the multimedia resource to the playback multi-speed corresponding to the swipe amplitude.

In the embodiments of the present disclosure, the playback multi-speed of the multimedia resource is adjusted based on the playback multi-speed corresponding to the swipe amplitude, such that the adjustment of the playback multi-speed is matched with the interaction, the validity of the interaction is further improved, and the efficiency of human-computer interaction is improved.

In some embodiments, the method further includes: displaying a plurality of multi-speed controls on the playback interface in the multi-speed mode, wherein the plurality of multi-speed controls correspond to different playback multi-speeds; and determining the playback multi-speed corresponding to the swipe amplitude of the swipe operation in response to the swipe operation on the playback interface, and adjusting the playback multi-speed of the multimedia resource to the playback multi-speed corresponding to the swipe amplitude include: adjusting, in response to the swipe operation on the playback interface, the playback multi-speed of the multimedia resource to a playback multi-speed corresponding to a selected multi-speed control in the plurality of multi-speed controls based on the multi-speed control in the plurality of multi-speed controls selected by the swipe amplitude of the swipe operation.

In the embodiments of the present disclosure, the plurality of multi-speed controls are displayed, such that the required playback multi-speed can be selected conveniently, and the validity and accuracy of the multi-speed adjustment are improved.

In some embodiments, the method further includes: adjusting, in response to a trigger operation on any multi-speed control in the plurality of multi-speed controls, the playback multi-speed of the multimedia resource to a playback multi-speed corresponding to the any multi-speed control in the plurality of multi-speed controls.

In the embodiments of the present disclosure, the multi-speed control can be selected by various interaction operations, such that the flexibility and diversity of the interaction are improved.

In some embodiments, the method further includes: not displaying the plurality of multi-speed controls in the multi-speed mode in response to a duration from a current time to an operation time of the multi-speed adjust operation reaching a reference duration.

In the embodiments of the present disclosure, the plurality of multi-speed controls are displayed in performing the multi-speed adjust operation, disappear upon display of the multi-speed adjust operation for a period of time, and are re-displayed in the playback multi-speed, such that the flexibility of display of the plurality of multi-speed controls is improved.

In some embodiments, the method further includes: displaying a multi-speed progress bar on the playback interface in the multi-speed mode, wherein two ends of the multi-speed progress bar respectively correspond to an upper threshold and a lower threshold of the playback multi-speed.

Determining the playback multi-speed corresponding to the swipe amplitude of the swipe operation in response to the swipe operation on the playback interface, and adjusting the playback multi-speed of the multimedia resource to the playback multi-speed corresponding to the swipe amplitude include: adjusting, in response to the swipe operation on the playback interface, the playback multi-speed of the multimedia resource to a playback multi-speed corresponding to a first multi-speed progress based on the first multi-speed progress determined by the swipe amplitude of the swipe operation.

In the embodiments of the present disclosure, the playback multi-speed of the multimedia resource can be adjusted based on the playback multi-speed corresponding to the swipe amplitude, such that the adjustment of the playback multi-speed is matched with the interaction, the validity of the interaction is further improved, and the efficiency of human-computer interaction is improved.

In some embodiments, the method further includes: adjusting, in response to a drag operation on the multi-speed progress bar, the playback multi-speed of the multimedia resource to a playback multi-speed corresponding to a second multi-speed progress based on the second multi-speed progress determined by the drag operation.

In the embodiments of the present disclosure, the playback multi-speed can be adjusted based on various interaction operations, such that the flexibility and diversity of the interaction are improved.

In some embodiments, the multi-speed adjust operation is a swipe operation to a third direction or a swipe operation to a fourth direction, wherein the swipe operation to the third direction and the swipe operation to the fourth direction correspond to different adjust directions of the playback multi-speed.

In the embodiments of the present disclosure, the multi-speed adjust operation is set as the swipe operation to the third direction or the swipe operation to the fourth direction, and the swipe operation to the third direction and the swipe operation to the fourth direction correspond to different adjust directions of the multi-speed, such that adjustments of the playback progress in different directions are achieved by the swipe operations to different directions, and the flexibility of the adjustments of the playback progress is further improved.

In some embodiments, the method further includes: performing a vibration prompt, wherein a vibration strength of the vibration prompt is positively correlated with the adjusted playback multi-speed.

In the embodiments of the present disclosure, the vibration prompt is performed, and the vibration strength is matched with the playback multi-speed, such that the completeness of interaction is ensured, the interaction efficiency is increased, and the user experience is improved.

In some embodiments, the method further includes: exiting the multi-speed mode in response to an end of the first multi-speed set operation.

In the embodiments of the present disclosure, the multi-speed mode is exited in response to the end of the first multi-speed set operation, such that the convenience of exiting the multi-speed mode is improved.

In some embodiments, the method further includes: displaying a close control of the multi-speed mode on the playback interface in the multi-speed mode, wherein the close control is configured to allow exiting the multi-speed mode; and exiting the multi-speed mode in response to a trigger operation on the close control, or exiting the multi-speed mode in response to a trigger operation on the playback interface.

In the embodiments of the present disclosure, the multi-speed mode is exited by triggering the close control or the playback interface, such that the problem of keeping the multi-speed mode by maintaining the first multi-speed set operation is avoided, and the multi-speed mode can be kept without performing by the hands. Thus, the efficiency of human-computer interaction is improved.

Embodiments of the present disclosure provide a method for playing back a multimedia resource. In the method, in the case that the multimedia resource is played back in the multi-speed mode, the multimedia resource is continuously played back in the multi-speed mode upon adjustment of the playback progress in response to the progress adjust operation on the playback interface. As such, upon the adjustment of the playback progress, the multimedia resource is continuously played back in the multi-speed mode without triggering the multi-speed mode again, such that the multi-speed function and the progress adjust function are combined to a new function, the diversity of the interaction is increased, and the interaction efficiency is improved.

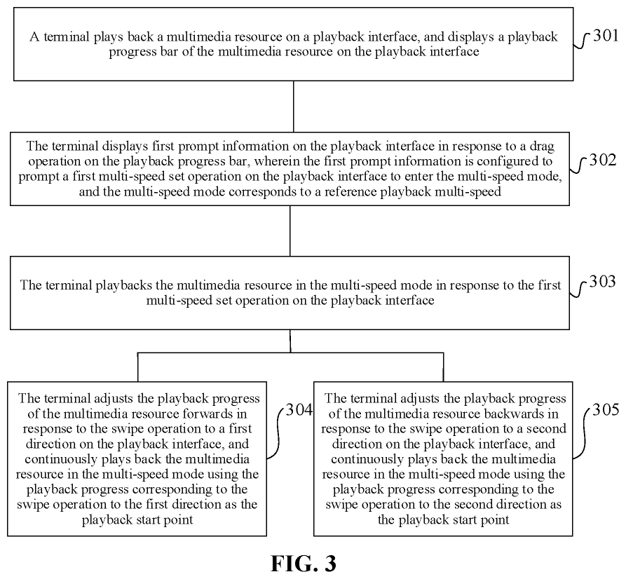

FIG. 2 is a basic flowchart of playback of the multimedia resource, and the processes of playing back the multimedia resource is further described based on FIG. 3 hereinafter. Referring to FIG. 3, FIG. 3 is a flowchart of another method for playing back a multimedia resource according to some embodiments of the present disclosure. The method is performed by the terminal and includes the following processes.

In S301, a terminal plays back a multimedia resource on a playback interface, and displays a playback progress bar of the multimedia resource on the playback interface.

In the embodiments of the present disclosure, a display position of the playback progress bar on the playback interface is set according to actual needs. For example, the display position of the playback progress bar on the playback interface is a top region or a bottom region of the playback interface. The embodiments of the present disclosure are described by taking the display position of the playback progress bar on the playback interface being the bottom region of the playback interface as an example.

In S302, the terminal displays first prompt information on the playback interface in response to a drag operation on the playback progress bar, wherein the first prompt information is configured to prompt a first multi-speed set operation on the playback interface to enter the multi-speed mode, and the multi-speed mode corresponds to a reference playback multi-speed.

In the embodiments of the present disclosure, entering the multi-speed mode indicates playback of the multimedia resource in the multi-speed mode. The first multi-speed set operation is an operation that causes or enables the playback at the multi-speed mode. The first prompt information indicates how to perform the first multi-speed set operation to enter the multi-speed mode.

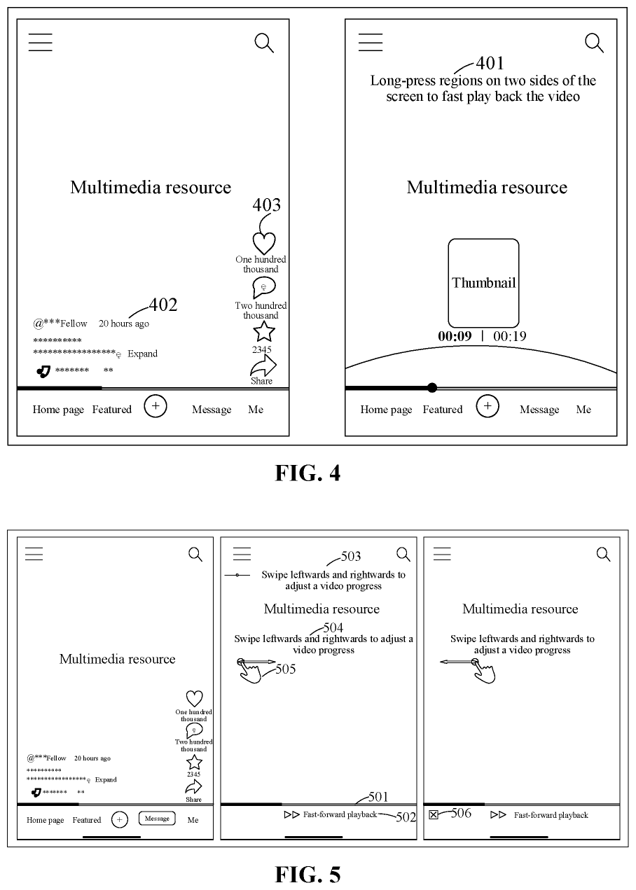

In the embodiments of the present disclosure, a display position of the first prompt information on the playback interface is set according to actual needs. The embodiments of the present disclosure are described by taking the display position of the first prompt information on the playback interface being the top region of the playback interface as an example. For example, referring to FIG. 4, FIG. 4 is a schematic diagram of a playback interface displaying first prompt information according to some embodiments of the present disclosure. The first prompt information 401 is displayed in the top region of the playback interface and is “long-press regions on two sides of the screen to fast play back the video.”

In the related art, for the function of the application, the terminal generally displays prompt information on how to use the function only once when the function is published for the first time, such that the prompt information is prone to being ignored. In addition, the prompt information only displays once and is not displayed for a second time, such that the user is incapable of getting full knowledge of the function or using the function. In the embodiments of the present disclosure, in the case that the playback progress is adjusted based on the playback progress bar, the prompt information on how to enter the multi-speed mode is displayed, such that the prompt information on the multi-speed function is fully output by the interrelation of the progress adjust function and the multi-speed function, the user has full knowledge of the multi-speed function, and the utilization of the multi-speed function is improved.

In some embodiments, in performing the drag operation on the progress bar, a thumbnail of the multimedia resource corresponding to the drag operation is further displayed, and a time point of playback progress corresponding to the drag operation and a total duration of the multimedia resource are displayed, such that the timeliness of display of the information in adjusting the progress is ensured, the user is capable of getting full knowledge of the progress adjustment, the feedback of the progress adjustment is achieved, and the completeness of interaction is ensured.

In the embodiments of the present disclosure, the above processes are described by taking display of the first prompt information in response to the drag operation on the playback progress bar as an example. In some embodiments, the method further includes the following processes for saving the display resources. The terminal displays the first prompt information on the playback interface in response to the drag operation on the playback progress bar and a cumulative use duration of an object in using an application not reaching a first reference duration, the playback interface being an interface in the application, and does not display the first prompt information on the playback interface in response to the drag operation on the playback progress bar and the cumulative use duration reaching the first reference duration. The first prompt information is displayed in the case that the cumulative use duration is small, and the first prompt information is not displayed in the case that the cumulative use duration is large. That is, the first prompt information is displayed in the case that the user is not accustomed to the application, such that the user is capable of getting full knowledge of the function prompted by the first prompt information. In the case that the user uses the application for a period of time and is accustomed to the application, the user has full knowledge of the function prompted by the first prompt information, and thus the first prompt information is not displayed, such that reasonability of display of the first prompt information is improved, and consumption in displaying the resource on the interface is reduced on the premise that the user has knowledge of the prompt information.

In some embodiments, the terminal displays the first prompt information on the playback interface in response to the drag operation on the playback progress bar and a number of times of entering the multi-speed mode based on the first multi-speed set operation on the playback interface not reaching a first reference number, and does not display the first prompt information on the playback interface in response to the drag operation on the playback progress bar and the number of the times of entering the multi-speed mode based on the first multi-speed set operation on the playback interface reaching the first reference number. That is, the first prompt information is only displayed in the case that the number of times of using the multi-speed function is small, and the first prompt information is not displayed in the case that the number of times of using the multi-speed function is large. That is, the first prompt information is displayed in the case that the user is not accustomed to the application, such that the user is capable of getting full knowledge of the function prompted by the first prompt information. In the case that the user uses the application for a period of time and is accustomed to the application, the user has full knowledge of the function prompted by the first prompt information, and thus the first prompt information is not displayed, such that the reasonability of display of the first prompt information is improved, and consumption in displaying the resource on the interface is reduced on the premise that the user has knowledge of the prompt information.

In some embodiments, the terminal displays the first prompt information on the playback interface in response to the drag operation on the playback progress bar, and does not display the first prompt information in response to a display duration of the first prompt information reaching a second reference duration, such that the first prompt information disappears upon display of the first prompt information for a period of time, and the prompt function is achieved, consumption in displaying the resource on the interface is reduced, and conciseness of the interface is improved.

In the embodiments illustrated in FIG. 3, S302 is taken as an example to describe the process of displaying the first prompt information on the playback interface in response to the adjust operation on the playback progress bar by the terminal prior to S303. In some embodiments, prior to S303, the terminal does not display the first prompt information on the playback interface and directly plays back the multimedia resource in the multi-speed mode in response to the first multi-speed set operation on the playback interface. Correspondingly, prior to S303, the playback progress bar is displayed on the playback interface, and the terminal only adjusts the playback progress bar of the multimedia resource in response to the drag operation on the playback progress bar and does not display the first prompt information on the playback interface.

The first reference duration and the second reference duration are thresholds used to determine whether to display the first prompt information, and are set and adjusted according to actual needs. For example, the first reference duration is one week, one month, and the like, and the second reference duration is one second, five seconds, ten seconds, and the like. The object refers to the user of the terminal. In some embodiments, the cumulative use duration of the object in using the application indicates a sum of history durations of using the application by the object. Furthermore, the cumulative application duration indicates a sum of history durations of using the playback progress bar by the object. In some embodiments, the cumulative use duration indicates a sum of history durations of display of the first prompt information in response to the drag operation on the playback progress bar.

In S303, the terminal playbacks the multimedia resource in the multi-speed mode in response to the first multi-speed set operation on the playback interface.

In some embodiments, the terminal playbacks the multimedia resource in the multi-speed mode in response to the first multi-speed set operation on any region in the playback interface, such that the simplification of entering the multi-speed mode based on the first multi-speed set operation is improved. The operation may be a long-press operation, a tap operation or a double tap operation for example. In some embodiments, the terminal playbacks the multimedia resource in the multi-speed mode in response to the first multi-speed set operation on a reference region in the playback interface. The reference region may be set on the sides of the screen (a left edge portion or a right edge portion for example). In this way, it is easy to enter the multi-speed mode by an operation on a region of the playback interface rather than selecting a specific control, and the case of entering the multi-speed mode due to the false touch is reduced. The reference region is set and adjusted according to actual needs. The embodiments of the present disclosure are described by taking the reference region being regions on two side of the playback interface as an example, and the regions on two side are at least one of regions on left and right sides and upper and lower sides. In some examples, instruction on the first multi-speed set operation is provided by the first prompt information such as “long-press regions on two sides of the screen to fast play back the video”.

In some embodiments, the embodiments of the present disclosure further include at least one of the following processes. In some embodiments, the terminal displays the prompt information of the multi-speed mode in the playback progress bar in the multi-speed mode, wherein the prompt information of the multi-speed mode is configured to prompt current playback of the multimedia resource in the multi-speed mode. In this case, display of the prompt information of the multi-speed mode in the multi-speed mode makes the user know the current status of the multi-speed mode and feedback the result of triggering the multi-speed mode, such that the completeness of interaction is improved. For example, referring to FIG. 5, FIG. 5 is a schematic diagram of a playback interface displaying prompt information of a multi-speed mode according to some embodiments of the present disclosure. The prompt information 502 in the multi-speed mode is displayed below the playback progress bar 501, and the prompt information 502 in the multi-speed mode is “playing back in multi-speed.”

In some embodiments, the terminal displays third prompt information on the playback interface in the multi-speed mode, wherein the third prompt information is configured to prompt the progress adjust operation on the playback interface to adjust a playback progress of the multimedia resource. In this case, in the multi-speed mode, the prompt information on how to adjust the playback progress is displayed, such that the prompt information of the progress adjust function is fully output by the interrelation of the progress adjust function and the multi-speed function, the user has knowledge of the function, and the user is promoted to perform the progress adjust function. That is, the user is urged to use the progress adjust function.

In the embodiments of the present disclosure, a display position of the third prompt information on the playback interface is set according to actual needs. For example, the display position of the third prompt information on the playback interface is a top region or a center region of the playback interface, and the like. The third prompt information includes at least one of a text prompt information and icon prompt information. Referring to FIG. 5, the third prompt information includes first text prompt information 503 in the top region of the playback interface, and second text prompt information 504 and icon prompt information 505 in the center region of the playback interface.

In the embodiments of the present disclosure, the above processes are described by taking display of the third prompt information in the multi-speed mode as an example. In some embodiments, the method further includes the following processes for saving the display resources. The terminal displays the third prompt information on the playback interface in the multi-speed mode in response to a cumulative use duration of an object in using an application not reaching a fifth reference duration, the playback interface being an interface in the application, and does not display the third prompt information on the playback interface in the multi-speed mode in response to the cumulative use duration reaching the fifth reference duration. The third prompt information is displayed in the case that the cumulative use duration is small, and the third prompt information is not displayed in the case that the cumulative use duration is large. That is, the third prompt information is displayed in the case that the user is not accustomed to the application, such that the user is capable of getting full knowledge of the function prompted by the third prompt information. In the case that the user uses the application for a period of time and is accustomed to the application, the user has full knowledge of the function prompted by the third prompt information, and thus the third prompt information is not displayed, such that reasonability of display of the third prompt information is improved, and consumption in displaying the resource on the interface is reduced on the premise that the user has knowledge of the prompt information.

In some embodiments, the terminal displays the third prompt information on the playback interface in the multi-speed mode in response to a number of times of adjusting the playback progress based on the progress adjust operation not reaching a third reference number, and does not display the third prompt information on the playback interface in the multi-speed mode in response to the number of the times of adjusting the playback progress based on the progress adjust operation reaching the third reference number. The third prompt information is displayed in the case that the number of times of using the progress adjust function is small, and the third prompt information is not displayed in the case that the number of times of using the progress adjust function is large. That is, the third prompt information is displayed in the case that the user is not accustomed to the application, such that the user is capable of getting full knowledge of the function prompted by the third prompt information. In the case that the user uses the application for a period of time and is accustomed to the application, the user has full knowledge of the function prompted by the third prompt information, and thus the third prompt information is not displayed, such that the reasonability of display of the third prompt information is improved, and consumption in displaying the resource on the interface is reduced on the premise that the user has knowledge of the prompt information.

In some embodiments, the terminal displays the third prompt information on the playback interface in the multi-speed mode, and does not display the third prompt information in response to a display duration of the third prompt information reaching a sixth reference duration. The third prompt information disappears upon display of the third prompt information for a period of time, such that the prompt function is achieved, consumption in displaying the resource on the interface is reduced, and conciseness of the interface is improved.

In some embodiments, the cumulative use duration of the object in using the application indicates a sum of history durations of using the application by the object. Furthermore, the cumulative application duration indicates a sum of history durations of adjusting the playback progress bar based on the progress adjust operation. In some embodiments, the cumulative use duration indicates a sum of durations of displaying the third prompt information in the multi-speed mode.

In the embodiments of the present disclosure, the above embodiments are described by taking the display of the third prompt information in the multi-speed mode as an example. In some embodiments, the terminal does not display the third prompt information in the multi-speed mode, directly adjusts the playback progress of the multimedia resource in response to the progress adjust operation on the playback interface, and continuously plays back the multimedia resource in the multi-speed mode using the playback progress corresponding to the progress adjust operation as the playback start point.

In some embodiments, the terminal performs a vibration prompt in response to a first multi-speed set operation on the playback interface to prompt to enter the multi-speed mode, such that the feedback on the first multi-speed set operation is achieved, and the completeness of interaction is improved.

In S304, the terminal adjusts the playback progress of the multimedia resource forwards in response to a swipe operation to a first direction on the playback interface, and continuously plays back the multimedia resource in the multi-speed mode, wherein the playback progress corresponding to the swipe operation to the first direction is used as the playback start point. A start point of the swipe operation is a start contact point of a gesture of the swipe operation on the playback interface, and an end point of the swipe operation is an end contact point of a gesture of the swipe operation on the playback interface. The playback progress corresponding to the swipe operation to the first direction is the end point of the swipe operation, and the terminal continuously plays back the multimedia resource in the multi-speed mode after the swipe operation is completed. The adjustment of the playback progress of the multimedia resource forwards refers to adjusting the playback to the time point where the video has been played back. The swipe operation is performed on any region on the playback interface or a reference region on the playback interface. In some embodiments, the third prompt information is configured to prompt the progress adjust operation on the playback interface as illustrated in FIG. 5.

In the embodiments of the present disclosure, the first direction is set and adjusted according to actual needs. For example, the first direction is an upward, downward, leftward, or rightward direction. The embodiments of the present disclosure are described by taking the first direction being the leftward direction as an example (see the third playback interface in FIG. 5). Forward adjustment of the playback progress of the multimedia resource indicates fastening the playback progress.

In S305, the terminal adjusts the playback progress of the multimedia resource backwards in response to the swipe operation to a second direction on the playback interface, and continuously plays back the multimedia resource in the multi-speed mode, wherein the playback progress corresponding to the swipe operation to the second direction is used as the playback start point. A start point of the swipe operation is a start contact point of a gesture of the swipe operation on the playback interface, and an end point of the swipe operation is an end contact point of a gesture of the swipe operation on the playback interface. The playback progress corresponding to the swipe operation to the second direction is the end point of the swipe operation, and the terminal continuously plays back the multimedia resource in the multi-speed mode after the swipe operation is completed. The adjustment of the playback progress of the multimedia resource backwards refers to adjusting the playback to the time point where the video has not played back. The swipe operation is performed on any region or a reference region on the playback interface. In some embodiments, the third prompt information is configured to prompt the progress adjust operation on the playback interface as illustrated in FIG. 5.

In the embodiments of the present disclosure, the second direction is set and adjusted according to actual needs. In some embodiments, the second direction is opposite to the first direction. For example, the first direction is the leftward direction (see the third playback interface in FIG. 5), and the second direction is the rightward direction (see the second playback interface in FIG. 5).

In the embodiments of the present disclosure, the process of continuously playing back, in response to the progress adjust operation on the playback interface, the multimedia resource in the multi-speed mode using playback progress corresponding to the progress adjust operation as the playback start point is achieved by S304 and S305. In the embodiments, the progress adjust operation is set as the swipe operation to the first direction or the swipe operation to the second direction, and the swipe operation to the first direction and the swipe operation to the second direction correspond to different adjust directions of the playback progress, such that adjustments of the playback progress in different directions are achieved by the swipe operations to different directions, and the flexibility of adjustments of the playback progress is further improved. S304 and S305 are only an implementation of continuously playing back, in response to the progress adjust operation on the playback interface, the multimedia resource in the multi-speed mode using playback progress corresponding to the progress adjust operation as the playback start point, and the process can be achieved in other implementations, which is not repeated herein.

It should be noted that numbering of S304 and S305 is only convenient for description, and is not intended to limit the order of performing S304 and S305. S304 may also be performed prior to or upon S305, which is not repeated herein.

In some embodiments, the terminal exits the multi-speed mode in response to the end of the first multi-speed set operation, such that the convenience of exiting the multi-speed mode is improved. Correspondingly, in the case that the first multi-speed set operation is the long-press operation, the multi-speed mode is exited upon an end of the long-press operation, that is, the multi-speed mode is exited upon release of the long-press operation. Correspondingly, continuously playing back, in response to the progress adjust operation on the playback interface, the multimedia resource in the multi-speed mode upon adjustment of the playback progress by the terminal is achieved based on continuous gesture operations of the first multi-speed set operation and the progress adjust operation on the playback interface. In the case that the first multi-speed set operation and the progress adjust operation are respectively the long-press operation and the swipe operation, upon entering the multi-speed mode in response to the long-press operation on the playback interface, the terminal adjusts the playback progress in response to the swipe operation on the playback interface while maintaining the long-press operation and continuously plays back the multimedia resource in the multi-speed mode in performing the long-press operation. That is, a combined gesture of a long-press operation on a point of the playback interface and then a swipe operation starting from this point, and keeping the long-press operation (e.g., a finger remains touching the screen during the swipe operation) accomplish the two tasks of adjustment on the playback progress and continuation of a multi-speed mode.

In some embodiments, the terminal continuously playbacks the multimedia resource in the multi-speed mode after a user stops the first multi-speed operation (e.g., stop a long press operation on the playback interface). The terminal is configured to display a close control of the multi-speed mode on the playback interface in the multi-speed mode, wherein the close control is configured to allow exiting the multi-speed mode. Correspondingly, the terminal exits the multi-speed mode in response to a trigger operation on the close control. In some embodiments, the terminal exits the multi-speed mode in response to a trigger operation on the playback interface. A display region of the close control on the playback interface is set according to actual needs. The embodiments of the present disclosure are described by taking the close control being displayed on a side of the playback progress bar as an example. For example, referring to FIG. 5, the close control 506 is displayed on a side of the playback progress bar. In the embodiments, the multi-speed mode is exited by triggering the close control or the playback interface, which provides an approach to close the multi-speed mode. In this way, it is not necessary to close the multi-speed mode by stopping the first multi-speed set operation (i.e., release of long-press operation). Because the availability of the close control, the multi-speed mode can be kept upon release of the long-press operation. Thus, the efficiency of human-computer interaction is improved.

In some embodiments, the text information and the interaction control are displayed on the playback interface. The text information is used to describe the multimedia resource, and the interaction control is used to achieve the forwarding, collection, and other interactions of the multimedia resource. In some embodiments, the terminal enters the multi-speed mode or conceals the text information and the interaction control in adjusting the playback progress in response to the first multi-speed set operation or the progress adjust operation, and the like, such that conciseness of the interface in the multi-speed mode or in adjusting the playback progress is ensured. For example, referring to FIG. 4, the text information 402 and the interaction control 403 are displayed on the playback interface in response to no entry into the multi-speed mode, and the text information 402 and the interaction control 403 are concealed in adjusting the playback progress.

Embodiments of the present disclosure provide a method for playing back a multimedia resource. In the method, in the case that the multimedia resource is played back in the multi-speed mode, the multimedia resource is continuously played back in the multi-speed mode upon adjustment of the playback progress in response to the progress adjust operation on the playback interface. As such, upon the adjustment of the playback progress, the multimedia resource is continuously played back in the multi-speed mode without the need to trigger the multi-speed mode again, such that the multi-speed function and the progress adjust function are combined to a new function, the diversity of the interaction is increased, and the interaction efficiency is improved.

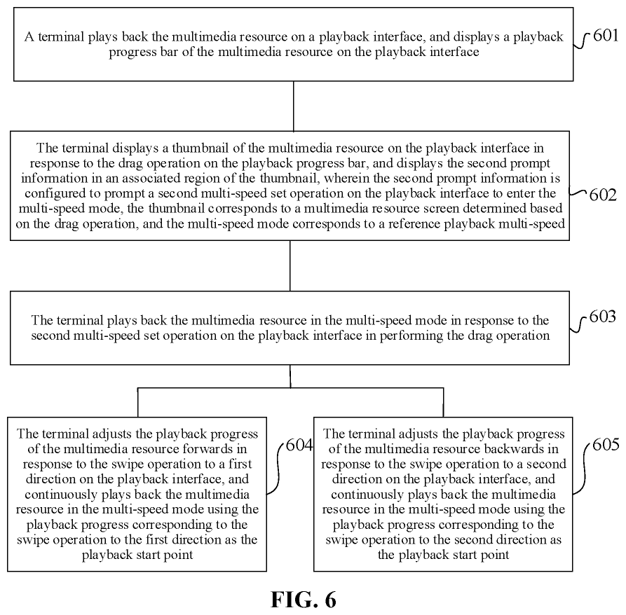

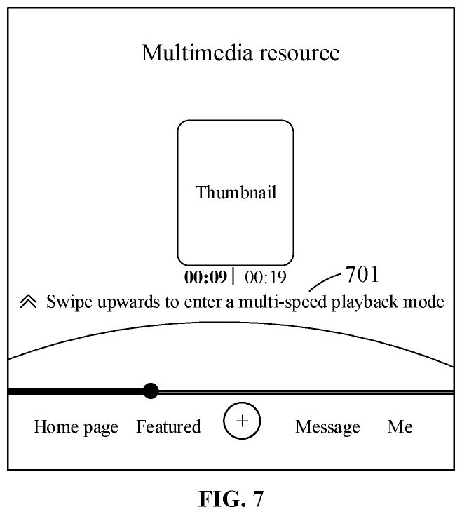

The embodiments of the present disclosure are described by taking entry into the multi-speed mode in response to the first multi-speed set operation in playing back the multimedia resource as an example based on the embodiments of FIG. 3. The following is described by taking entry into the multi-speed mode in response to the second multi-speed set operation in adjusting the playback progress as an example based on FIG. 6. Referring to FIG. 6, FIG. 6 is a flowchart of another method for playing back a multimedia resource according to some embodiments of the present disclosure. The method includes the following processes.

In S601, a terminal plays back a multimedia resource on a playback interface, and displays a playback progress bar of the multimedia resource on the playback interface.

In the embodiments of the present disclosure, S601 is similar to S301, which is not repeated herein.

In S602, the terminal displays a thumbnail of the multimedia resource on the playback interface in response to the drag operation on the playback progress bar, and displays the second prompt information in an associated region of the thumbnail, wherein the second prompt information is configured to prompt a second multi-speed set operation on the playback interface to enter the multi-speed mode, the thumbnail corresponds to a multimedia resource screen determined based on the drag operation, and the multi-speed mode corresponds to a reference playback multi-speed.

In the embodiments of the present disclosure, the second multi-speed set operation is set according to actual needs. For example, the second multi-speed set operation is an upward swipe operation or a downward swipe operation. The embodiments of the present disclosure are described by taking the second multi-speed set operation being the upward swipe operation as an example.

In the embodiments of the present disclosure, the associated region of the thumbnail is a region on the playback interface where the distance from the thumbnail does not exceed a reference distance, that is, a nearby region of the thumbnail. The associated region of the thumbnail is left region, a right region, an upper region, or a lower region of the thumbnail. The embodiments of the present disclosure are described by taking the associated region of the thumbnail being the lower region of the thumbnail as an example. For example, referring to FIG. 7, FIG. 7 is a schematic diagram of a playback interface displaying second prompt information according to some embodiments of the present disclosure. The second prompt information 701 is displayed on the lower region of the thumbnail. The second prompt information is configured to prompt a second multi-speed set operation on the playback interface to enter the multi-speed mode, and includes information on how to enable a multi-speed playback mode. For example, the second prompt information 701 is “swipe upwards to enter a multi-speed playback mode.”

In the embodiments of the present disclosure, the process of displaying the second prompt information on the playback interface in response to the drag operation on the playback progress bar is achieved based on S602. In the embodiments, the second prompt information is displayed in the nearby region of the thumbnail, such that the second prompt information is more noticeable, the possibility of acquiring the second prompt information by the user is increased, the display effect of the second prompt information is improved, and the user is reminded to use the multi-speed function and is instructed on how to enter the multi-speed playback mode based on the second prompt information. It should be noted that S602 is only on implementation of displaying the second prompt information, and the process of displaying the second prompt information can be achieved in other implementations, which is not limited herein.

The embodiments of the present disclosure are described by taking the display of the second prompt information in response to the drag operation on the playback progress bar as an example in the above processes. In some embodiments, the method further includes the following processes for saving the display resources. The terminal displays the second prompt information on the playback interface in response to the drag operation on the playback progress bar and a cumulative use duration of an object in using an application not reaching a third reference duration, the playback interface being an interface in the application, and does not display the second prompt information on the playback interface in response to the drag operation on the playback progress bar and the cumulative use duration reaching the third reference duration. The second prompt information is displayed in the case that the cumulative use duration is small, and the second prompt information is not displayed in the case that the cumulative use duration is large. That is, the second prompt information is displayed in the case that the user is not accustomed to the application, such that the user is capable of getting full knowledge of the function prompted by the second prompt information. In the case that the user uses the application for a period of time and is accustomed to the application, the user has full knowledge of the function prompted by the second prompt information, and thus the second prompt information is not displayed, such that reasonability of display of the second prompt information is improved, and consumption in displaying the resource is reduced on the premise that the user has knowledge of the prompt information.

In some embodiments, the terminal displays the second prompt information on the playback interface in response to the drag operation on the playback progress bar and a number of times of entering the multi-speed mode based on the second multi-speed set operation on the playback interface not reaching a second reference number, and does not display the second prompt information on the playback interface in response to the drag operation on the playback progress bar and the number of the times of entering the multi-speed mode based on the second multi-speed set operation on the playback interface reaching the second reference number, such that the second prompt information is displayed in the case that the number of times of using the multi-speed function is small, and the second prompt information is not displayed in the case that the number of times of using the multi-speed function is large. That is, the second prompt information is displayed in the case that the user is not accustomed to the application, such that the user is capable of getting full knowledge of the function prompted by the second prompt information. In the case that the user uses the application for a period of time and is accustomed to the application, the user has full knowledge of the function prompted by the second prompt information, and thus the second prompt information is not displayed, such that the reasonability of display of the second prompt information is improved, and consumption in displaying the resource on the interface is reduced on the premise that the user has knowledge of the prompt information.

In some embodiments, the terminal displays the second prompt information on the playback interface in response to the drag operation on the playback progress bar, and does not display the second prompt information in response to a display duration of the second prompt information reaching a fourth reference duration, such that the second prompt information disappears upon display of the second prompt information for a period of time, and the prompt function is implemented, consumption in displaying the resource on the interface is reduced, and conciseness of the interface is improved.

The third reference duration and the fourth reference duration are set and adjusted according to actual needs. The third reference duration is the same or different from the first reference duration, and the fourth reference duration is the same or different from the second reference duration. In some embodiments, the cumulative use duration of the object in using the application indicates a sum of history durations of using the application by the object. Furthermore, the cumulative application duration indicates a sum of history durations of using the playback progress bar by the object. In some embodiments, the cumulative use duration indicates a sum of history durations of display of the first prompt information in response to the drag operation on the playback progress bar.

In the embodiments of the present disclosure, the process of displaying the second prompt information on the playback interface in response to the adjust operation on the playback progress bar by the terminal prior to S603 is described by taking 602 as an example. In some embodiments, prior to S603, the terminal does not display the second prompt information on the playback interface and directly plays back the multimedia resource in the multi-speed mode in response to the second multi-speed set operation on the playback interface. Correspondingly, prior to S603, the playback progress bar is displayed on the playback interface, and the terminal only adjusts the playback progress bar of the multimedia resource in response to the drag operation on the playback progress bar but does not display the second prompt information on the playback interface.

In S603, the terminal plays back the multimedia resource in the multi-speed mode in response to the second multi-speed set operation on the playback interface while the drag operation is performed on the progress bar.

In the embodiments of the present disclosure, in performing the drag operation, the terminal plays back the multimedia resource in the multi-speed mode in response to the second multi-speed set operation on the playback interface. That is, the multi-speed mode is entered in adjusting the playback progress by continuous gesture operations (i.e., the drag operation on the progress bar and the second multi-speed set operation of swiping upwards on the playback interface while the drag operation is performing). In the embodiments, the new interaction gesture is developed. In the case that the second multi-speed set operation is the upward swipe operation, the new interaction gesture is the continuous gesture operation of the drag operation and the upward swipe operation. In the embodiments, the rapid interaction manner of entering the multi-speed mode in adjusting the playback progress is achieved by the new interaction gesture, the diversity of the interaction is increased, and the interaction efficiency is improved.

In S604, the terminal adjusts the playback progress of the multimedia resource forwards in response to the swipe operation to a first direction on the playback interface, and continuously plays back the multimedia resource to the multi-speed mode using the playback progress corresponding to the swipe operation to the first direction as the playback start point.

In S605, the terminal adjusts the playback progress of the multimedia resource backwards in response to the swipe operation to a second direction on the playback interface, and continuously plays back the multimedia resource in the multi-speed mode using the playback progress corresponding to the swipe operation to the second direction as the playback start point.

In the embodiments of the present disclosure, S604 to S605 are similar to S304 to S305, which are not repeated herein.

In the embodiments of the present disclosure, a temporary-stated function prompt method is provided. Based on the guide prompt of the interaction functions in the multi-speed mode, in the progress adjustment state, and other temporary states, more users are capable of getting knowledge and using new functions of the product, and the user is guided to find and use the new functions. By combining the multi-speed function with the progress adjustment function, and performing the guide prompt, the functions in the products are correlated. By the prompt, the user is reminded or instructed to use the function, the learning cost of the user is reduced, and the use efficiency of the product is improved. The method in the embodiments of the present disclosure is applicable to advanced interaction and functional guidance of the playback progress bar in a scenario of vertical screen video players. By combining the multi-speed function with the progress adjustment function, interaction gestures are innovated, similar functions are linked, interaction gestures are simplified, and the product flexibility and use efficiency are improved.

The embodiments of the present disclosure are described by taking the guide prompt of the multi-speed function and the progress adjustment function as an example. In some embodiments, the suspense function, the multi-speed function, and the progress adjustment function are combined. That is, in the temporary state of suspending, the guide prompt information of the multi-speed function or the progress adjustment function is displayed, and the multi-speed mode is entered from the suspense state. In some embodiments, the suspense function, the multi-speed function, or the progress adjustment function can be combined with other functions to display the guide prompt information of other functions, which are not repeated herein.

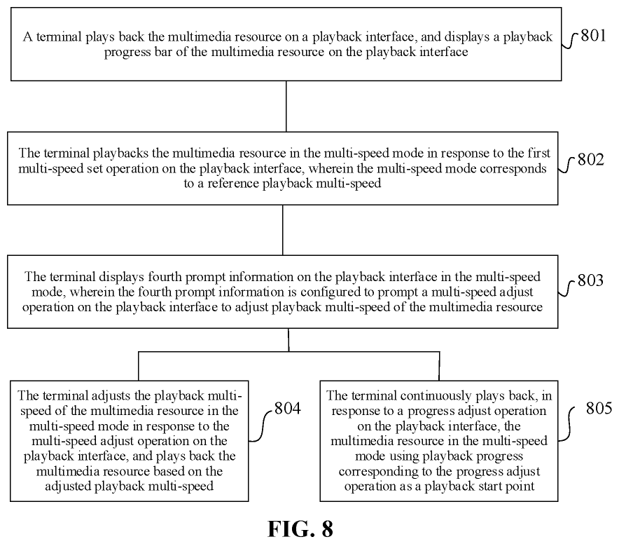

The embodiments of the present disclosure are described by taking the adjustment of the playback progress in the multi-speed mode as an example based on the embodiments of FIG. 3 and FIG. 6. The following describes the adjustment of the playback progress in the multi-speed mode based on FIG. 8. Referring to FIG. 8, FIG. 8 is a flowchart of another method for playing back a multimedia resource according to some embodiments of the present disclosure. The method includes the following processes.

In S801, a terminal plays back a multimedia resource on a playback interface, and displays a playback progress bar of the multimedia resource on the playback interface.

In the embodiments of the present disclosure, S801 is similar to S301, which is not repeated herein.

In S802, the terminal playbacks the multimedia resource in the multi-speed mode in response to the first multi-speed set operation on the playback interface, wherein the multi-speed mode corresponds to a reference playback multi-speed.

In the embodiments of the present disclosure, S802 is similar to S303, which is not repeated herein.

In S803, the terminal displays fourth prompt information on the playback interface in the multi-speed mode, wherein the fourth prompt information is configured to prompt a multi-speed adjust operation on the playback interface to adjust a playback multi-speed of the multimedia resource.

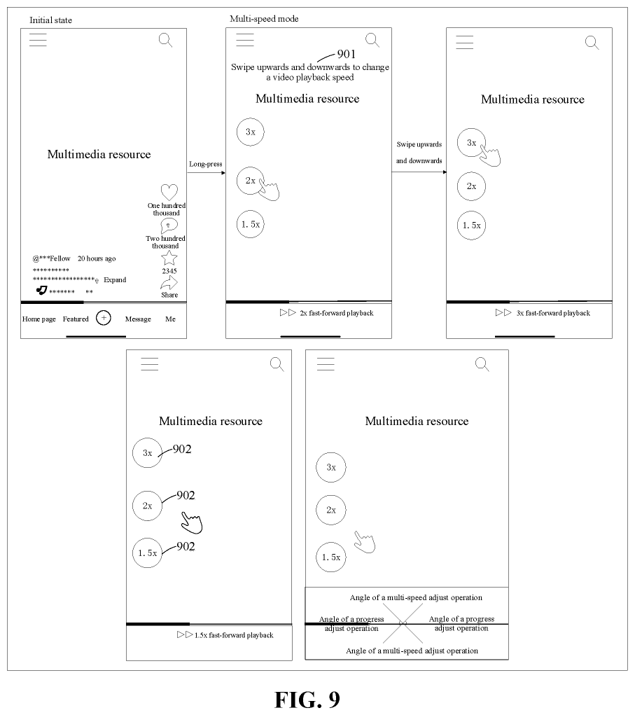

In the embodiments of the present disclosure, a display position of the fourth prompt information on the playback interface is set according to actual needs. The embodiments of the present disclosure are described by taking the display position of the fourth prompt information on the playback interface being the top region as an example. For example, referring to FIG. 9, FIG. 9 is a schematic diagram of a playback interface displaying fourth prompt information according to some embodiments of the present disclosure. The fourth prompt information 901 is displayed in the top region and is “swipe upwards and downwards to change the video playback speed.”

In some embodiments, the multi-speed adjust operation is a swipe operation. In some embodiments, the multi-speed adjust operation is a swipe operation to any direction. In some embodiments, the multi-speed adjust operation is a swipe operation to a third direction or a swipe operation to a fourth direction. The swipe operation to the third direction and the swipe operation to the fourth direction correspond to two different adjustment directions of the playback multi-speed.

The third direction and the fourth direction are set and adjusted according to actual needs. In some embodiments, the third direction is opposite to the fourth direction. For example, the third direction is an upward direction, and the fourth direction is a downward direction. The swipe operation to the third direction and the swipe operation to the fourth direction correspond to two different adjustment directions of the playback multi-speed. Correspondingly, the third direction corresponds to an increment direction of the playback multi-speed, and the fourth direction corresponds to a reduction direction of the playback multi-speed. In some embodiments, the third direction corresponds to a reduction direction of the playback multi-speed, and the fourth direction corresponds to an increment direction of the playback multi-speed. In some embodiments, the multi-speed set operation is the swipe operation to the third direction or the swipe operation to the fourth direction. The swipe operation to the third direction and the swipe operation to the fourth direction correspond to two different adjustment directions of the playback multi-speed. By the swipe operation to different directions, the adjustment of the playback multi-speed in different directions is achieved, and the flexibility of adjusting the playback multi-speed is improved.

In the embodiments of the present disclosure, the above processes are described by taking display of the fourth prompt information in the multi-speed mode as an example. In some embodiments, the method further includes the following processes for saving the display resources. The terminal displays the fourth prompt information on the playback interface in the multi-speed mode in response to a cumulative use duration of an object in using an application not reaching a seventh reference duration, the playback interface being an interface in the application, and does not display the fourth prompt information on the playback interface in the multi-speed mode in response to the cumulative use duration reaching the seventh reference duration. The fourth prompt information is displayed in the case that the cumulative use duration is small, and the fourth prompt information is not displayed in the case that the cumulative use duration is large. That is, the fourth prompt information is displayed in the case that the user is not accustomed to the application, such that the user is capable of getting full knowledge of the function prompted by the fourth prompt information. In the case that the user uses the application for a period of time and is accustomed to the application, the user has full knowledge of the function prompted by the fourth prompt information, and thus the fourth prompt information is not displayed, such that reasonability of display of the fourth prompt information is improved, and consumption in displaying the resource on the interface is reduced on the premise that the user has knowledge of the prompt information.

In some embodiments, the terminal displays the fourth prompt information on the playback interface in the multi-speed mode in response to a number of times of adjusting the playback progress based on the multi-speed adjust operation not reaching a fourth reference number, and does not display the fourth prompt information on the playback interface in the multi-speed mode in response to the number of the times of adjusting the playback progress based on the multi-speed adjust operation reaching the fourth reference number. The fourth prompt information is displayed in the case that the number of times of using the progress adjust function is small, and the fourth prompt information is not displayed in the case that the number of times of using the progress adjust function is large. That is, the fourth prompt information is displayed in the case that the user is not accustomed to the application, such that the user is capable of getting full acknowledge of the function prompted by the fourth prompt information. In the case that the user uses the application for a period of time and is accustomed to the application, the user has full knowledge of the function prompted by the fourth prompt information, and thus the fourth prompt information is not displayed, such that the reasonability of display of the fourth prompt information is improved, and consumption in displaying the resource on the interface is reduced on the premise that the user has knowledge of the prompt information.

In some embodiments, the terminal displays the fourth prompt information on the playback interface in the multi-speed mode, and does not display the third prompt information in response to a display duration of the fourth prompt information reaching an eighth reference duration. The fourth prompt information disappears upon display of the fourth prompt information for a period of time, such that the prompt function is implemented, consumption in displaying the resource on the interface is reduced, and conciseness of the interface is improved.

In some embodiments, the cumulative use duration of the object in using the application indicates a sum of history durations of using the application by the object. Furthermore, the cumulative application duration indicates a sum of history durations of adjusting the playback progress bar based on the progress adjust operation. In some embodiments, the cumulative use duration indicates a sum of durations of displaying the fourth prompt information in the multi-speed mode.

In the embodiments of the present disclosure, the process of displaying the fourth prompt information in the multi-speed mode by the terminal is described prior to S804 by taking S803 as an example. In some embodiments, prior to S804, the terminal does not display the fourth prompt information on the playback interface in the multi-speed mode, directly adjusts the playback multi-speed of the multimedia resource in the multi-speed mode in response to the multi-speed adjust operation on the playback interface, and plays back the multimedia resource based on the adjusted playback multi-speed. Correspondingly, prior to S804, the terminal only plays back the multimedia resource on the playback interface in the multi-speed mode, and does not display the fourth prompt information on the playback interface.

In S804, the terminal adjusts the playback multi-speed of the multimedia resource in the multi-speed mode in response to the multi-speed adjust operation on the playback interface, and plays back the multimedia resource based on the adjusted playback multi-speed.

In some embodiments, the multi-speed adjust operation is a swipe operation. Correspondingly, the processes of adjusting the playback multi-speed of the multimedia resource in the multi-speed mode in response to the multi-speed adjust operation on the playback interface, and playing back the multimedia resource based on the adjusted playback multi-speed by the terminal include: determining a playback multi-speed corresponding to a swipe amplitude of a swipe operation in response to the swipe operation on the playback interface, and adjusting the playback multi-speed of the multimedia resource to the playback multi-speed corresponding to the swipe amplitude by the terminal. In the embodiments, the playback multi-speed of the multimedia resource is adjusted based on the playback multi-speed corresponding to the swipe amplitude, such that the adjustment of the playback multi-speed is matched with the interaction, the validity of the interaction is further improved, and the efficiency of human-computer interaction is improved.

In some embodiments, the terminal displays a plurality of multi-speed controls on the playback interface in the multi-speed mode, wherein the plurality of multi-speed controls correspond to different playback multi-speeds. Correspondingly, the process of determining the playback multi-speed corresponding to the swipe amplitude of the swipe operation in response to the swipe operation on the playback interface, and adjusting the playback multi-speed of the multimedia resource to the playback multi-speed corresponding to the swipe amplitude by the terminal include: displaying a plurality of multi-speed controls in the multi-sped mode; adjusting, in response to the swipe operation on the playback interface and based on a multi-speed control selected by the swipe operation by the user, the playback multi-speed of the multimedia resource corresponding to the selected multi-speed control. In the embodiments of the present disclosure, the plurality of multi-speed controls are displayed, such that the required playback multi-speed can be selected conveniently, and the validity and accuracy of the multi-speed adjustment are improved. In some embodiments, the multi-speed control is selected based on the swipe operation or the trigger operation. Correspondingly, the terminal adjusts the playback multi-speed of the multimedia resource to the playback multi-speed corresponding to the multi-speed control in response to the trigger operation on any multi-speed control in the plurality of multi-speed controls, such that the flexibility and diversity of the interaction are improved.

The playback multi-speeds corresponding to the plurality of multi-speed controls are set according to actual needs, for example, 1.5×, 2×, 3×, and the like. x represents the multi-speed. For convenient adjustment of the multi-speed, the plurality of multi-speed controls are arranged in an ascending or descending order of playback multi-speeds. The display positions of the plurality of multi-speed controls on the playback interface are set and adjusted according to actual needs. The embodiments of the present disclosure are described by taking the plurality of multi-speed controls being displayed on a left side of the playback interface as an example. For example, referring to FIG. 9, texts of different playback multi-speeds are displayed on the plurality of multi-speed controls 902, and the plurality of multi-speed controls are displayed on the left region of the playback interface.

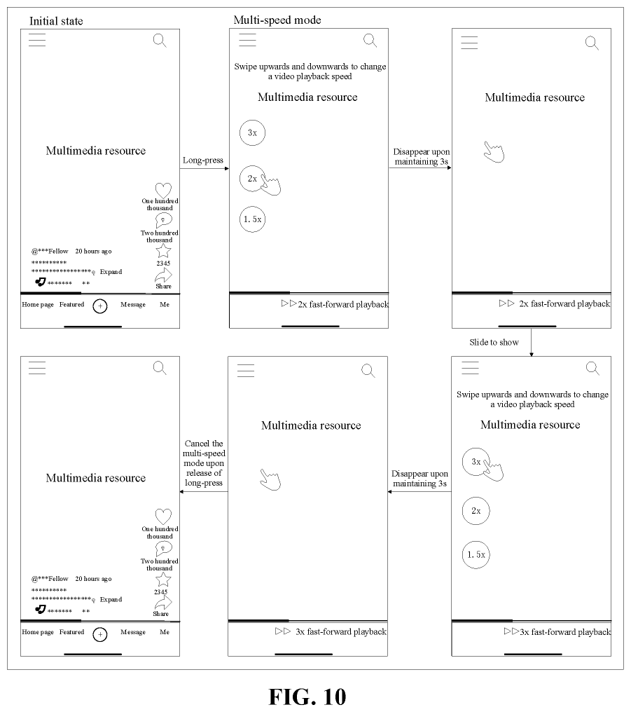

In some embodiments, the plurality of multi-speed controls are hidden, that is, not displayed on the playback interface, such that conciseness of the playback interface is ensured. In some embodiments, the plurality of multi-speed controls are displayed on the playback interface in response to the multi-speed adjust operation, that is, the swipe operation on the playback interface. In some embodiments, the terminal does not display the plurality of multi-speed controls in response to a duration from a current time to an operation time of the multi-speed adjust operation reaching a reference duration, and displays the plurality of multi-speed controls in response to a next multi-speed adjust operation on the playback interface. For example, referring to FIG. 10, FIG. 10 is a schematic diagram of playback interfaces showing a process of adjusting a playback multi-speed according to some embodiments of the present disclosure. The process is described according the order from the playback interface on the top left to the playback interface on the top right, then to the playback interface on the bottom right, and then from the playback interface on the bottom right to the playback interface on the bottom left. In the embodiments, after a first multi-speed set operation (e.g., a long-press on the playback interface), the terminal displays a playback interface (the image on the top middle) where fourth prompt information is displayed to prompt information on a multi-speed adjust operation to adjust playback multi-speed of the multimedia resource (e.g., “Swipe upwards and downwards to change a video playback speed”).

In this interface, the plurality of multi-speed controls (3×, 2×, 1.5×) are displayed. The image on the top middle further illustrates that a hand is swiped to the multi-speed control 2×. The prompt information is displayed on the progress bar area to indicate that the playback is at a state of 2× fast-forward play back. Upon maintaining of a finger on the multi-speed control for a preset duration (e.g., 3 seconds), the terminal display a playback interface as illustrated in the top right image, where multi-speed controls disappears. When the playback multi-speed is changed by a swipe operation, the multi-speed controls are again displayed. As shown in the bottom right image, the multi-speed controls are displayed, and a finger is shown to press on the multi-speed control 3×. The prompt information is displayed on the progress bar area to indicate that the playback is at a state of 3× fast-forward play back. Upon maintaining of a finger on the multi-speed control for a preset duration (e.g., 3 seconds), the terminal display a playback interface as illustrated in the bottom middle image, where multi-speed controls disappears and the finger keeps on pressing on the interface. Upon release of long-press, the multi-speed mode is cancelled. The terminal display a playback interface as illustrated in the bottom left image. In this way, the flexibility of display of the plurality of multi-speed controls is improved.

In some embodiments, in the case that the plurality of multi-speed controls are not displayed on the playback interface, the terminal again displays the plurality of multi-speed controls in the multi-speed mode in response to the trigger operation on the display regions of the plurality of multi-speed controls on the playback interface, such that the user can flexibly control whether to display the plurality of multi-speed controls, and the flexibility of the interaction is improved.

In some embodiments, the terminal displays a multi-speed progress bar on the playback interface in the multi-speed mode, and two ends of the multi-speed progress bar respectively correspond to an upper threshold and a lower threshold of the playback multi-speed.

Correspondingly, determining, by the terminal, the playback multi-speed corresponding to the swipe amplitude of the swipe operation in response to the swipe operation on the playback interface, and adjusting the playback multi-speed of the multimedia resource to the playback multi-speed corresponding to the swipe amplitude include: adjusting, in response to the swipe operation on the playback interface, the playback multi-speed of the multimedia resource to a playback multi-speed corresponding to a first multi-speed progress by the terminal based on the first multi-speed progress determined by the swipe amplitude of the swipe operation. The upper threshold and the lower threshold are set according to actual needs, which is not limited herein. In the embodiments, the playback multi-speed of the multimedia resource is adjusted based on the playback multi-speed corresponding to the swipe amplitude, such that the adjustment of the playback multi-speed is matched with the interaction, the validity of the interaction is further improved, and the efficiency of human-computer interaction is improved.

In some embodiments, the multi-speed progress is determined based on the swipe operation and the drag operation. Correspondingly, the terminal adjusts, in response to a drag operation on the multi-speed progress bar, the playback multi-speed of the multimedia resource to a playback multi-speed corresponding to a second multi-speed progress based on the second multi-speed progress determined by the drag operation, such that the diversity and the flexibility of the interaction are improved.

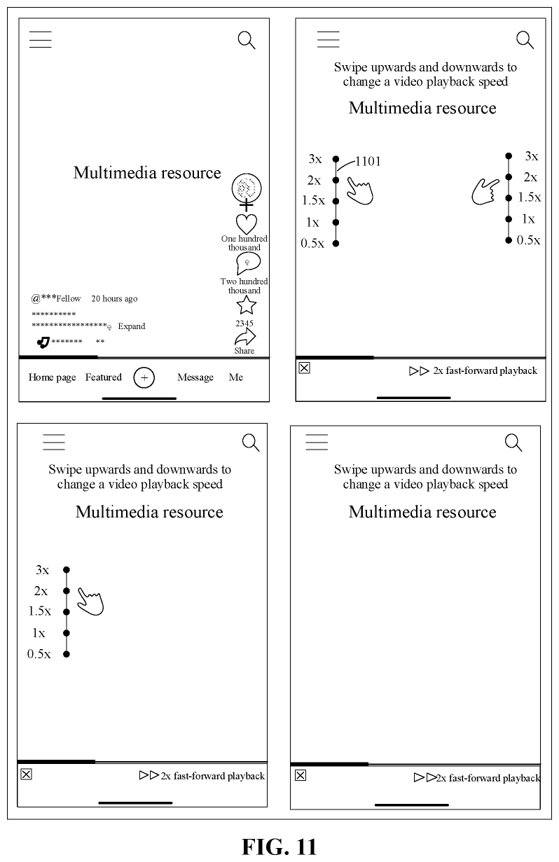

In some embodiments, the multi-speed progress bar includes a plurality of multi-speed nodes, and the plurality of multi-speed nodes correspond to different playback multi-speeds. A number of the plurality of multi-speed nodes is set and adjusted according to actual needs, and is a limited number. The playback multi-speeds corresponding to two adjacent multi-speed nodes have a stepped multi-speed difference, that is, a plurality of playback multi-speeds corresponding to a plurality of multi-speed nodes are discrete. For example, referring to FIG. 11, FIG. 11 is a schematic diagram of another playback interface of adjusting a playback multi-speed according to some embodiments of the present disclosure. The multi-speed progress bar 1101 includes a plurality of multi-speed nodes corresponding to the playback multi-speeds of 0.5×, 1×, 1.5×, 2×, and 3×. Each of the plurality of multi-speed nodes corresponds to a round point. Correspondingly, a multi-speed node is selected in the case that the swipe operation swipes to a round point corresponding to any multi-speed node.

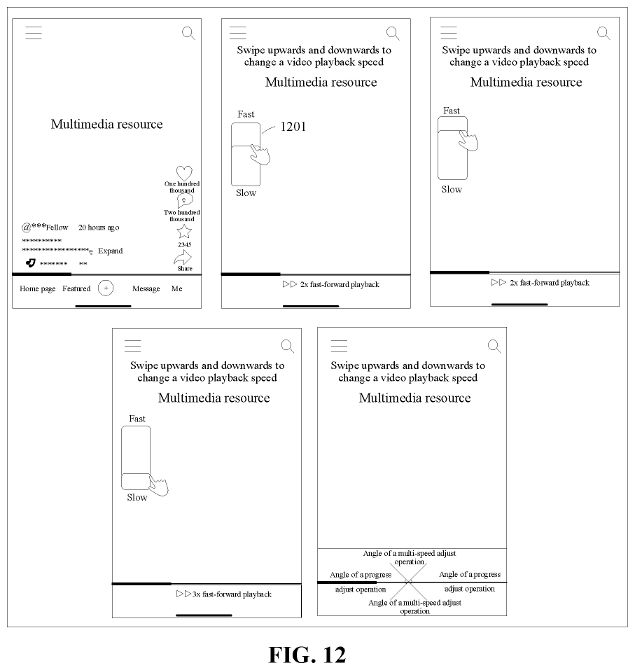

In some embodiments, the playback multi-speeds corresponding to a range between the upper threshold and the lower threshold in the multi-speed progress bar do not have an obvious step, and the playback multi-speeds are discrete. Referring to FIG. 12, FIG. 12 is a schematic diagram of a playback interface displaying a multi-speed progress bar according to some embodiments of the present disclosure. Prompt information of “fast” and “slow” is displayed on two ends of the multi-speed progress bar 1201.

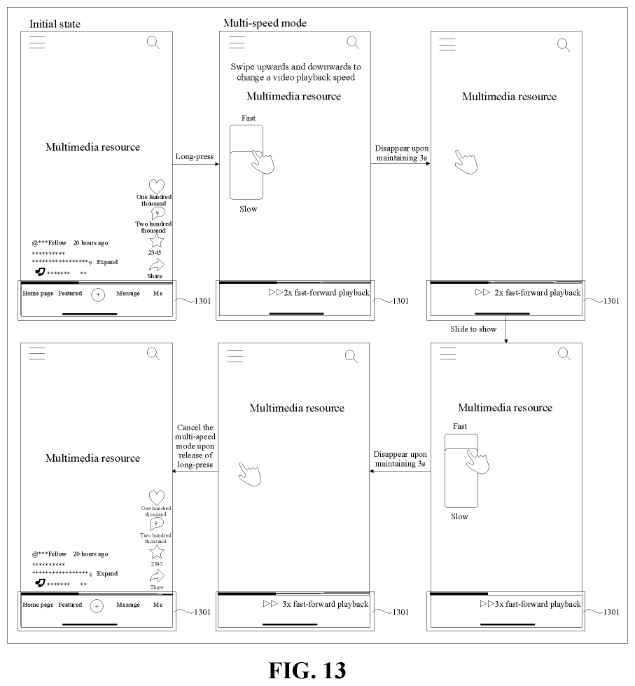

In some embodiments, the multi-speed progress bar is hidden, that is, not displayed on the playback interface, such that conciseness of the playback interface is ensured. In some embodiments, the multi-speed progress bar is displayed on the playback interface in response to the multi-speed adjust operation, that is, the swipe operation on the playback interface. In some embodiments, the terminal does not display the multi-speed progress bar in response to a duration from a current time to an operation time of the multi-speed adjust operation reaching a reference duration, and again displays the multi-speed progress bar in response to a next multi-speed adjust operation on the playback interface. For example, referring to FIG. 13, FIG. 13 is a schematic diagram illustrating a process of displaying a playback interface in response to adjust a playback multi-speed according to some embodiments of the present disclosure. In FIG. 13, the process is illustrated in the order similar to that illustrated in FIG. 10, and will not be described in detail. In the embodiments, the multi-speed progress bar is displayed in performing the swipe operation, disappears upon a preset duration, and is again displayed in changing the playback multi-speed. FIG. 13 further illustrates that the multi-speed mode is canceled upon release of long-press. In this way, the flexibility of display of the multi-speed progress bar is improved, and the validity and the accuracy of the multi-speed adjust are improved based on the displayed multi-speed progress bar on the premise that conciseness of the playback interface is ensured.

In some embodiments, the terminal performs a vibration prompt upon adjusting the playback multi-speed of the multimedia resource in response to the multi-speed adjust operation on the playback interface, and a vibration strength of the vibration prompt is positively correlated with the adjusted playback multi-speed. That is, the greater the adjusted playback multi-speed, the greater the vibration strength of the vibration prompt. As such, the vibration prompt is performed, and the vibration strength is matched with the playback multi-speed, such that the completeness of interaction is ensured by the vibration prompt, the interaction efficiency is increased, and the user experience is improved.

In some embodiments, upon entry into the multi-speed mode, a current playback multi-speed is displayed in a bottom guide bar of the playback interface, such that the completeness of interaction of the multi-speed adjust operation is improved. For example, referring to FIG. 13, the current playback multi-speed is displayed in the bottom guide bar 1301. In the illustrated example, the bottom guide bar displays “2× fast-forward playback” and “3× fast-forward playback” are displayed corresponding to the multi-speed control performed by the user.

In the embodiments of the present disclosure, the multi-speed selection is further refined based on the simple upward and downward operations in the multi-speed mode. For example, in the case that the current multi-speed mode corresponds to a multi-speed of 1.5×, and the multi-speed of 1.5× is slow for the user, the multi-speed is adjusted to a faster multi-speed of 2× or 3× by the simple upward operation. In the case that the current multi-speed mode corresponds to a multi-speed of 1.5×, and the multi-speed of 1.5× is fast for the user, the multi-speed is adjusted to a slower multi-speed of 1.0× or 0.5× by the simple downward operation. In the method in the embodiments of the present disclosure, the playback multi-speed is quickly adjusted based on the simple upward or downward operation, such that the user operation is greatly convenient, the user can adjust the playback multi-speed at any time and conveniently according to the requirements of the multi-speed, and the requirements of quick and convenient adjustments of the playback multi-speed of the user are greatly met.

In S805, the terminal continuously plays back, in response to a progress adjust operation on the playback interface, the multimedia resource in the multi-speed mode using a playback progress corresponding to the progress adjust operation as a playback start point.

In the embodiments of the present disclosure, S805 can be achieved by S304 to S305, or may be achieved in other manners, which is not limited herein.

It should be noted that in the case that the multi-speed adjust operation and the progress adjust operation are both the swipe operations, the multi-speed adjust operation and the progress adjust operation are swipe operations to different directions. For example, the multi-speed adjust operation is the upward swipe operation or the downward swipe operation, and the progress adjust operation is the leftward swipe operation or the rightward swipe operation.

In some embodiments, the upward swipe operation or the downward swipe operation refers to the swipe operation that is vertically upward or downward, and the leftward swipe operation or the rightward swipe operation refers to the swipe operation that is horizontally leftward or rightward. In some embodiments, the upward swipe operation or the downward swipe operation refers to an oblique swipe operation with an angle less than a first reference angle from a vertical direction, the leftward swipe operation or the rightward swipe operation refers to an oblique swipe operation with an angle less than a second reference angle from a horizontal direction, and a sum of the first reference angle and the second reference angle is not greater than 90°. For example, the first reference angle and the second reference angle are both 45°, such that the terminal can accurately identify the multi-speed adjust operation and the progress adjust operation, and the confusion of the two operations is avoided. For example, referring to the exemplary embodiments of FIG. 9 and FIG. 12, on the bottom region of the playback interface, angle ranges or a swipe directions are instructed. The swipe direction corresponding to the multi-speed adjust operation is a swipe operation in a direction of about 45 degree from a horizontal direction and the swipe direction corresponding to the progress adjust operation is in a horizontal direction.

It should be noted that the numerals of S804 and S805 are only convenient for description, and are not intended to limit the performing order of S804 and S805. S804 can be performed prior to or upon S805, which is not limited herein.

In the embodiments of the present disclosure, a manner of quickly adjusting the playback multi-speed is provided, which is applicable to a quick interaction manner in a scenario of a vertical screen video player, and the convenient, low-cost, and more flexible quick human-computer interaction is achieved. Thus, the use efficiency and the use duration are further improved, and the user experience is improved.

In some practices, in adjusting the playback multi-speed, the set panel is first opened, a multi-speed set position is found from the set panel, and the desired multi-speed is selected and is used for playback. In this way, in the case that the user needs to adjust the playback multi-speed again, the above processes should be repeated, and thus the efficiency is less. In the embodiments of the present disclosure, the terminal randomly adjusts the playback multi-speed in the multi-speed mode based on the multi-speed adjust operation on the playback interface, such that the quick adjustment on the playback multi-speed in the multi-speed mode is achieved, the playback multi-speed is adjusted randomly and repeatedly, the efficiency of adjusting the playback multi-speed is improved, and the efficiency of human-computer interaction is improved.

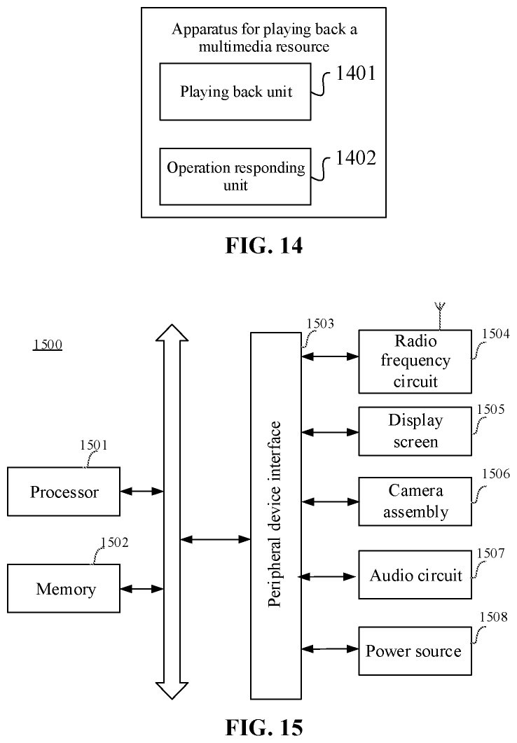

FIG. 14 is a block diagram of an apparatus for playing back a multimedia resource according to some embodiments of the present disclosure. Referring to FIG. 14, the apparatus includes a playback unit 1401 and an operation responding unit 1402.

The playback unit 1401 is configured to play back the multimedia resource on a playback interface.

The operation responding unit 1402 is configured to play back the multimedia resource in a multi-speed mode in response to a first multi-speed set operation on the playback interface, wherein the multi-speed mode corresponds to a reference playback multi-speed.

The operation responding unit 1402 is further configured to continuously play back, in response to a progress adjust operation on the playback interface, the multimedia resource in the multi-speed mode using a playback progress corresponding to the progress adjust operation as a playback start point.

In some embodiments, the progress adjust operation is a swipe operation to a first direction or a swipe operation to a second direction, wherein the swipe operation to the first direction and the swipe operation to the second direction correspond to different adjust directions of the playback progress.

In some embodiments, a playback progress bar of the multimedia resource is displayed on the playback interface, and the operation responding unit 1402 is further configured to: display first prompt information on the playback interface in response to a drag operation on the playback progress bar, wherein the first prompt information is configured to prompt the first multi-speed set operation on the playback interface to enter the multi-speed mode; or display first prompt information on the playback interface in response to the drag operation on the playback progress bar and a cumulative use duration of an object in using an application not reaching a first reference duration, wherein the playback interface is an interface in the application, and not display the first prompt information on the playback interface in response to the drag operation on the playback progress bar and the cumulative use duration reaching the first reference duration; or display first prompt information on the playback interface in response to a drag operation on the playback progress bar and a number of times of entering the multi-speed mode based on the first multi-speed set operation on the playback interface not reaching a first reference number, and not display first prompt information on the playback interface in response to the drag operation on the playback progress bar and the number of the times of entering the multi-speed mode based on the first multi-speed set operation on the playback interface reaching the first reference number; or display first prompt information on the playback interface in response to a drag operation on the playback progress bar, and not display the first prompt information in response to a display duration of the first prompt information reaching a second reference duration.

In some embodiments, a playback progress bar of the multimedia resource is displayed on the playback interface, and the operation responding unit 1402 is further configured to: display second prompt information on the playback interface in response to a drag operation on the playback progress bar, wherein the second prompt information is configured to prompt a second multi-speed set operation on the playback interface to enter the multi-speed mode; or display second prompt information on the playback interface in response to a drag operation on the playback progress bar and a cumulative use duration of an object in using an application not reaching a third reference duration, wherein the playback interface is an interface in the application, and not display the second prompt information on the playback interface in response to the drag operation on the playback progress bar and the cumulative use duration reaching the third reference duration; or display second prompt information on the playback interface in response to a drag operation on the playback progress bar and a number of times of entering the multi-speed mode based on the second multi-speed set operation on the playback interface not reaching a second reference number, and not display the second prompt information on the playback interface in response to the drag operation on the playback progress bar and the number of the times of entering the multi-speed mode based on the second multi-speed set operation on the playback interface reaching the second reference number; or display second prompt information on the playback interface in response to a drag operation on the playback progress bar, and not display the second prompt information in response to a display duration of the second prompt information reaching a fourth reference duration.

In some embodiments, the operation responding unit 1402 is further configured to display a thumbnail of the multimedia resource on the playback interface in response to the drag operation on the playback progress bar, and display the second prompt information in an associated region of the thumbnail, wherein the thumbnail corresponds to a multimedia resource screen determined based on the drag operation.

In some embodiments, the operation responding unit 1402 is further configured to play back the multimedia resource in the multi-speed mode in response to the second multi-speed set operation on the playback interface in performing the drag operation.

In some embodiments, a playback progress bar of the multimedia resource is displayed on the playback interface, and the apparatus further includes a display unit configured to perform at least one of:
displaying prompt information of the multi-speed mode in the playback progress bar in the multi-speed mode, wherein the prompt information of the multi-speed mode is configured to prompt current playback of the multimedia resource in the multi-speed mode; and
displaying third prompt information on the playback interface in the multi-speed mode, wherein the third prompt information is configured to prompt the progress adjust operation on the playback interface to adjust a playback progress of the multimedia resource; or displaying third prompt information on the playback interface in the multi-speed mode in response to a cumulative use duration of an object in using an application not reaching a fifth reference duration, the playback interface being an interface in the application, and not displaying the third prompt information on the playback interface in the multi-speed mode in response to the cumulative use duration reaching the fifth reference duration; or displaying third prompt information on the playback interface in the multi-speed mode in response to a number of times of adjusting the playback progress based on the progress adjust operation not reaching a third reference number, and not displaying the third prompt information on the playback interface in the multi-speed mode in response to the number of the times of adjusting the playback progress based on the progress adjust operation reaching the third reference number; or displaying third prompt information on the playback interface in the multi-speed mode, and not displaying the third prompt information in response to a display duration of the third prompt information reaching a sixth reference duration.

In some embodiments, the display unit is further configured to: display fourth prompt information on the playback interface in the multi-speed mode, wherein the fourth prompt information is configured to prompt a multi-speed adjust operation on the playback interface to adjust playback multi-speed of the multimedia resource; or display fourth prompt information on the playback interface in the multi-speed mode in response to a cumulative use duration of an object in using an application not reaching a seventh reference duration, the playback interface being an interface in the application, and not display the fourth prompt information on the playback interface in the multi-speed mode in response to the cumulative use duration reaching the seventh reference duration; or display fourth prompt information on the playback interface in the multi-speed mode in response to a number of times of adjusting the playback multi-speed based on the multi-speed adjust operation not reaching a fourth reference number, and not display the fourth prompt information on the playback interface in the multi-speed mode in response to the number of the times of adjusting the playback multi-speed based on the multi-speed adjust operation reaching the fourth reference number; or display fourth prompt information on the playback interface in the multi-speed mode, and not display the fourth prompt information in response to a display duration of the fourth prompt information reaching an eighth reference duration.

In some embodiments, the operation responding unit 1402 is further configured to adjust the playback multi-speed of the multimedia resource in the multi-speed mode in response to the multi-speed adjust operation on the playback interface, and play back the multimedia resource based on the adjusted playback multi-speed.

In some embodiments, the operation responding unit 1402 is configured to determine a playback multi-speed corresponding to a swipe amplitude of a swipe operation in response to the swipe operation on the playback interface, and adjust the playback multi-speed of the multimedia resource to the playback multi-speed corresponding to the swipe amplitude.

In some embodiments, the display unit is further configured to display a plurality of multi-speed controls on the playback interface in the multi-speed mode, wherein the plurality of multi-speed controls correspond to different playback multi-speeds; and the operation responding unit 1402 is configured to adjust, in response to the swipe operation on the playback interface, the playback multi-speed of the multimedia resource to a playback multi-speed corresponding to a selected multi-speed control in the plurality of multi-speed controls based on the multi-speed control in the plurality of multi-speed controls selected by the swipe amplitude of the swipe operation.

In some embodiments, the operation responding unit 1402 is further configured to: adjust, in response to a trigger operation on any multi-speed control in the plurality of multi-speed controls, the playback multi-speed of the multimedia resource to a playback multi-speed corresponding to the any multi-speed control in the plurality of multi-speed controls in the multi-speed mode.

In some embodiments, the display unit is further configured to: not display the plurality of multi-speed controls in the multi-speed mode in response to a duration from a current time to an operation time of the multi-speed adjust operation reaching a reference duration; and display the plurality of multi-speed controls in response to the multi-speed adjust operation on the playback interface.

In some embodiments, the display unit is further configured to display a multi-speed progress bar on the playback interface in the multi-speed mode, wherein two ends of the multi-speed progress bar respectively correspond to an upper threshold and a lower threshold of the playback multi-speed; and the operation responding unit 1402 is further configured to adjust, in response to the swipe operation on the playback interface, the playback multi-speed of the multimedia resource to a playback multi-speed corresponding to a first multi-speed progress based on the first multi-speed progress determined by the swipe amplitude of the swipe operation.

In some embodiments, the operation responding unit 1402 is further configured to: adjust, in response to a drag operation on the multi-speed progress bar, the playback multi-speed of the multimedia resource to a playback multi-speed corresponding to a second multi-speed progress based on the second multi-speed progress determined by the drag operation.

In some embodiments, the multi-speed adjust operation is a swipe operation to a third direction or a swipe operation to a fourth direction, wherein the swipe operation to the third direction and the swipe operation to the fourth direction correspond to different adjust directions of the playback multi-speed.

In some embodiments, the apparatus further includes a vibrating unit, configured to perform a vibration prompt, wherein a vibration strength of the vibration prompt is positively correlated with the adjusted playback multi-speed.

In some embodiments, the operation responding unit 1402 is further configured to exit the multi-speed mode in response to an end of the first multi-speed set operation.

In some embodiments, the display unit is further configured to: display a close control of the multi-speed mode in the multi-speed mode, wherein the close control is configured to allow exiting the multi-speed mode; and exit the multi-speed mode in response to a trigger operation on the close control; or exit the multi-speed mode in response to a trigger operation on the playback interface.

An apparatus for playing back a multimedia resource is provided in the embodiments of the present disclosure. In the case that the multimedia resource is played back in the multi-speed mode, the multimedia resource is continuously played back in the multi-speed mode upon adjustment of the playback progress in response to the progress adjust operation on the playback interface. As such, upon the adjustment of the playback progress, the multimedia resource is continuously played back in the multi-speed mode without triggering the multi-speed mode, such that the multi-speed function and the progress adjust function are combined, a new function is developed, the diversity of the interaction is increased, and the interaction efficiency is improved.

Specific manners of performing the operations of the units in the apparatus in the above embodiments are described in the corresponding method embodiments, which are not repeated herein.

FIG. 15 is a schematic block diagram of a terminal according to some embodiments of the present disclosure. The terminal 1500 may be a smart mobile phone, a tablet computer, a moving picture experts group audio layer III player, a moving picture experts group audio layer IV player, a desktop computer, or a laptop computer. The terminal 1500 may also be referred to as a user equipment, a portable terminal, a laptop terminal, a desktop terminal, or the like.

Generally, the terminal 1500 includes a processor 1501 and a memory 1502.

In some embodiments, the processor 1501 includes one or more processing cores, for example, a four-core processor, an eight-core processor, or the like. In some embodiments, the processor 1501 is implemented by at least one hardware of a digital signal processor (DSP), a field-programmable gate array (FPGA), and a programmable logic array (PLA). In some embodiments, the processor 1501 further includes a primary processor and a secondary processor. The primary processor is a processor configured to process data in an active state, and is also referred to as a central processing unit (CPU). The secondary processor is a low-power consumption processor configured to process data in a standby state. In some embodiments, the processor 1501 is integrated with a graphics processing unit (GPU), and the GPU is configured to render and draw the content to be displayed on the display screen. In some embodiments, the processor 1501 further includes an Artificial Intelligence (AI) processor configured to perform calculation operations related to machine learning.

In some embodiments, the memory 1502 includes one or more computer-readable storage media, and the computer-readable storage medium is non-transitory. In some embodiments, the memory 1502 further includes a high-speed random-access memory, and a non-volatile memory, for example, one or more magnetic disk storage devices or flash storage devices. In some embodiments, the non-transitory computer-readable storage medium in the memory 1502 is configured to store executable instructions. The executable instructions, when loaded and executed by the processor 1501, cause the processor 1501 to perform the method for playing back a multimedia resource according to the embodiments of the present disclosure.

In some embodiments, the terminal 1500 includes a peripheral device interface 1503 and at least one peripheral device. In some embodiments, the processor 1501, the memory 1502, and the peripheral device interface 1503 are connected to each other via a bus or a signal line. In some embodiments, the peripheral device is connected to the peripheral device interface 1503 via a bus, a signal line, or a circuit board. Specifically, the peripheral device includes at least one of a radio frequency circuit 1504, a display screen 1505, a camera assembly 1506, an audio circuit 1507, and a power source 1508.

The peripheral device interface 1503 is configured to connect the at least one peripheral device related to input/output (I/O) to the processor 1501 and the memory 1502. In some embodiments, the processor 1501, the memory 1502, and the peripheral device interface 1503 are integrated on the same chip or circuit board. In some embodiments, any one or two of the processor 1501, the memory 1502, and the peripheral device interface 1503 are achieved on a separate chip or circuit board, which is not limited in the embodiments of the present disclosure.

The radio frequency circuit 1504 is configured to receive and transmit a radio frequency (RF) signal, which is also referred to as an electromagnetic signal. The radio frequency circuit 1504 is communicated with a communication network or another communication device via the electromagnetic signal. The radio frequency circuit 1504 converts an electrical signal to an electromagnetic signal and sends the signal, or converts a received electromagnetic signal to an electrical signal. In some embodiments, the radio frequency circuit 1504 includes: an antenna system, an RF transceiver, one or a plurality of amplifiers, a tuner, an oscillator, a digital signal processor, a codec chip set, a user identification module card, or the like. In some embodiments, the radio frequency circuit 1504 is communicated with another terminal based on at least one wireless communication protocol. The wireless communication protocol includes, but is not limited to: a world wide web, a metropolitan area network, an intranet, various generations of mobile communication networks (2G, 3G, 4G and 5G), a wireless local area network and/or a wireless fidelity (Wi-Fi) network. In some embodiments, the radio frequency circuit 1504 further includes a near-field communication (NFC)-related circuits, which is not limited in the present disclosure.

The display screen 1505 is configured to display a user interface (UI). In some embodiments, the UI includes graphics, texts, icons, videos, and any combination thereof. In the case that the display screen 1505 is a touch display screen, the display screen 1505 further has the capability of acquiring a touch signal on or above the surface of the display screen 1505. In some embodiments, the touch signal is input to the processor 1501 as a control signal for processing. In this case, the display screen 1505 is further configured to provide a virtual button and/or a virtual keyboard or keypad, which is also referred to as a soft button and/or a soft keyboard or keypad. In some embodiments, one display screen 1505 is provided, which is disposed on a front panel of the terminal 1500. In some embodiments, at least two display screens 1505 are provided, which are respectively disposed on different surfaces of the terminal 1500 or designed in a folded fashion. In some other embodiments, the display screen 1505 is a flexible display screen disposed on a bent surface or a folded surface of the terminal 1500. Even, the display screen 1505 is further disposed as an irregular pattern other than a rectangular, that is, a specially-shaped screen. In some embodiments, the display screen 1505 is fabricated from such materials as a liquid crystal display (LCD), an organic light-emitting diode (OLED), or the like.

The camera assembly 1506 is configured to capture an image or a video. In some embodiments, the camera assembly 1506 includes a front camera and/or a rear camera. Generally, the front camera is disposed on a front panel of the terminal, and the rear camera is disposed on a rear panel of the terminal. In some embodiments, at least two rear cameras are disposed, which are any one of a primary camera, a depth of field (DOF) camera, a wide-angle camera, and a long-focus camera, such that the primary camera and the DOF camera are fused to achieve the background virtualization function, and the primary camera and the wide-angle camera are fused to implement the panorama photographing and virtual reality (VR) photographing functions or other fused photographing functions. In some embodiments, the camera assembly 1506 further includes a flash. In some embodiments, the flash is a single-color temperature flash or a double-color temperature flash. The double-color temperature flash refers to a combination of a warm-light flash and a cold-light flash, which is used for light compensation under different color temperatures.

The audio circuit 1507 includes a microphone and a speaker. The microphone is configured to capture an acoustic wave of a user and an environment, and convert the acoustic wave to an electrical signal and output the electrical signal to the processor 1501 for further processing, or output to the radio frequency circuit 1504 to achieve voice communication. For the purpose of stereo capture or noise reduction, a plurality of such microphones are provided, which are disposed at different positions of the terminal 1500. In some embodiments, the microphone is a microphone array or an omnidirectional capturing microphone. The speaker is configured to convert an electrical signal from the processor 1501 or the radio frequency circuit 1504 to an acoustic wave. In some embodiments, the speaker is a traditional thin-film speaker, or a piezoelectric ceramic speaker. In the case that the speaker is a piezoelectric ceramic speaker, an electrical signal is converted to an acoustic wave audible by human beings, or an acoustic wave inaudible by human beings for the purpose of ranging or the like. In some embodiments, the audio circuit 1507 further includes a headphone plug.

The power source 1508 is configured to supply power for various assemblies in the terminal 1500. In some embodiments, the power source 1508 is an alternating current, a direct current, a disposable battery, or a rechargeable battery. In the case that the power source 1508 includes a rechargeable battery, the rechargeable battery is a wired charging battery or a wireless charging battery. The wired charging battery is a battery charged in a wired line, and the wireless charging battery is a battery changed in a wireless coil. The rechargeable battery also supports the supercharging technology.

Some embodiments of the present disclosure further provide a computer-readable storage medium storing instructions, for example, a memory including one or more instructions. The one or more instructions, when loaded and executed by a processor of a terminal, cause the processor to perform the method for playing back the multimedia resource according to the above embodiments. In some embodiments, the computer-readable storage medium is a read-only memory (ROM), a random-access memory (RAM), a compact disc ROM (CD-ROM), a magnetic tape, a floppy disk, an optical data storage device, or the like.

Some embodiments of the present disclosure further provide a computer program product including computer programs. The computer programs, when loaded and executed by a processor, cause the processor to perform the method for playing back the multimedia resource according to the above embodiments. In some embodiments, the computer programs involved in the embodiments of the present disclosure are deployed on a terminal for execution, or are loaded and run by multiple terminals at the same location, or are loaded and run by multiple terminals at the multiple locations and interconnected over a communication network. The terminals at the multiple locations and interconnected over a communication network can form a block-chain system.

All the embodiments of the present disclosure may be independently practiced, or practiced in combination with other embodiments, which are all considered as falling within the protection scope of the present disclosure.

What is claimed is:

1. A method for playing back a multimedia resource, comprising:
playing back the multimedia resource on a playback interface;
playing back the multimedia resource in a multi-speed mode in response to a first multi-speed set operation on the playback interface, wherein the multi-speed mode corresponds to a reference playback multi-speed; and
continuously playing back, in response to a progress adjust operation on the playback interface, the multimedia resource in the multi-speed mode, wherein a playback progress corresponding to the progress adjust operation is used as a playback start point.

2. The method according to claim 1, wherein the progress adjust operation is a swipe operation to a first direction or a swipe operation to a second direction on the playback interface, and wherein the swipe operation to the first direction and the swipe operation to the second direction correspond to different adjust directions of the playback progress.

3. The method according to claim 1, wherein a playback progress bar of the multimedia resource is displayed on the playback interface, and the progress adjust operation is a drag operation performed on the playback progress bar; and
the method further comprises:
displaying first prompt information on the playback interface in response to the drag operation on the playback progress bar, wherein the first prompt information is configured to prompt the first multi-speed set operation on the playback interface to enter the multi-speed mode; or
displaying first prompt information on the playback interface in response to the drag operation on the playback progress bar and a cumulative use duration of an object in using an application not reaching a first reference duration, wherein the playback interface is an interface in the application, and not displaying the first prompt information on the playback interface in response to the drag operation on the playback progress bar and the cumulative use duration reaching the first reference duration, wherein the first prompt information is configured to prompt the first multi-speed set operation on the playback interface to enter the multi-speed mode; or
displaying first prompt information on the playback interface in response to the drag operation on the playback progress bar and a number of times of entering the multi-speed mode based on the first multi-speed set operation on the playback interface not reaching a first reference number, and not displaying the first prompt information on the playback interface in response to the drag operation on the playback progress bar and the number of the times of entering the multi-speed mode based on the first multi-speed set operation on the playback interface reaching the first reference number, wherein the first prompt information is configured to prompt the first multi-speed set operation on the playback interface to enter the multi-speed mode; or
displaying first prompt information on the playback interface in response to the drag operation on the playback progress bar, and not displaying the first prompt information in response to a display duration of the first prompt information reaching a second reference duration, wherein the first prompt information is configured to prompt the first multi-speed set operation on the playback interface to enter the multi-speed mode.

4. The method according to claim 1, wherein a playback progress bar of the multimedia resource is displayed on the playback interface, and the progress adjust operation is a drag operation performed on the playback progress bar; and
the method further comprises:
displaying second prompt information on the playback interface in response to the drag operation on the playback progress bar, wherein the second prompt information is configured to prompt a second multi-speed set operation on the playback interface to enter the multi-speed mode; or
displaying second prompt information on the playback interface in response to the drag operation on the playback progress bar and a cumulative use duration of an object in using an application not reaching a third reference duration, wherein the playback interface is an interface in the application, and not displaying the second prompt information on the playback interface in response to the drag operation on the playback progress bar and the cumulative use duration reaching the third reference duration, wherein the second prompt information is configured to prompt a second multi-speed set operation on the playback interface to enter the multi-speed mode; or
displaying second prompt information on the playback interface in response to the drag operation on the playback progress bar and a number of times of entering the multi-speed mode based on the second multi-speed set operation on the playback interface not reaching a second reference number, and not displaying the second prompt information on the playback interface in response to the drag operation on the playback progress bar and the number of the times of entering the multi-speed mode based on the second multi-speed set operation on the playback interface reaching the second reference number, wherein the second prompt information is configured to prompt a second multi-speed set operation on the playback interface to enter the multi-speed mode; or
displaying second prompt information on the playback interface in response to the drag operation on the playback progress bar, and not displaying the second prompt information in response to a display duration of the second prompt information reaching a fourth reference duration, wherein the second prompt information is configured to prompt a second multi-speed set operation on the playback interface to enter the multi-speed mode.

5. The method according to claim 4, wherein said displaying the second prompt information on the playback interface in response to the drag operation on the playback progress bar comprises:
displaying a thumbnail of the multimedia resource on the playback interface in response to the drag operation on the playback progress bar, and displaying the second prompt information in an associated region of the thumbnail, wherein the thumbnail corresponds to a multimedia resource screen determined based on the drag operation.

6. The method according to claim 5, further comprising:
playing back the multimedia resource in the multi-speed mode in response to the second multi-speed set operation on the playback interface in performing the drag operation on the progress bar.

7. The method according to claim 1, wherein a playback progress bar of the multimedia resource is displayed on the playback interface; and
the method further comprises at least one of:
displaying prompt information of the multi-speed mode in the playback progress bar in the multi-speed mode, wherein the prompt information of the multi-speed mode is configured to prompt current playback of the multimedia resource in the multi-speed mode; and
displaying third prompt information on the playback interface in the multi-speed mode, wherein the third prompt information is configured to prompt a progress adjust operation on the playback interface to adjust a playback progress of the multimedia resource; or
displaying third prompt information on the playback interface in the multi-speed mode in response to a cumulative use duration of an object in using an application not reaching a fifth reference duration, the playback interface being an interface in the application, and not displaying the third prompt information on the playback interface in the multi-speed mode in response to the cumulative use duration reaching the fifth reference duration, wherein the third prompt information is configured to prompt a progress adjust operation on the playback interface to adjust a playback progress of the multimedia resource; or
displaying third prompt information on the playback interface in the multi-speed mode in response to a number of times of adjusting the playback progress based on the progress adjust operation not reaching a third reference number, and not displaying the third prompt information on the playback interface in the multi-speed mode in response to the number of the times of adjusting the playback progress based on the progress adjust operation reaching the third reference number, wherein the third prompt information is configured to prompt a progress adjust operation on the playback interface to adjust a playback progress of the multimedia resource; or
displaying third prompt information on the playback interface in the multi-speed mode, and not displaying the third prompt information in response to a display duration of the third prompt information reaching a sixth reference duration, wherein the third prompt information is configured to prompt a progress adjust operation on the playback interface to adjust a playback progress of the multimedia resource.

8. The method according to claim 1, further comprising:
displaying fourth prompt information on the playback interface in the multi-speed mode, wherein the fourth prompt information is configured to prompt a multi-speed adjust operation on the playback interface to adjust a playback multi-speed of the multimedia resource; or
displaying fourth prompt information on the playback interface in the multi-speed mode in response to a cumulative use duration of an object in using an application not reaching a seventh reference duration, the playback interface being an interface in the application, and not displaying the fourth prompt information on the playback interface in the multi-speed mode in response to the cumulative use duration reaching the seventh reference duration, wherein the fourth prompt information is configured to prompt a multi-speed adjust operation on the playback interface to adjust a playback multi-speed of the multimedia resource; or
displaying fourth prompt information on the playback interface in the multi-speed mode in response to a number of times of adjusting the playback multi-speed based on the multi-speed adjust operation not reaching a fourth reference number, and not displaying the fourth prompt information on the playback interface in the multi-speed mode in response to the number of the times of adjusting the playback multi-speed based on the multi-speed adjust operation reaching the fourth reference number, wherein the fourth prompt information is configured to prompt a multi-speed adjust operation on the playback interface to adjust a playback multi-speed of the multimedia resource; or
displaying fourth prompt information on the playback interface in the multi-speed mode, and not displaying the fourth prompt information in response to a display duration of the fourth prompt information reaching an eighth reference duration, wherein the fourth prompt information is configured to prompt a multi-speed adjust operation on the playback interface to adjust a playback multi-speed of the multimedia resource; and
adjusting the playback multi-speed of the multimedia resource in the multi-speed mode in response to the multi-speed adjust operation on the playback interface, and playing back the multimedia resource based on the adjusted playback multi-speed.

9. The method according to claim 8, wherein said adjusting the playback multi-speed of the multimedia resource in response to the multi-speed adjust operation on the playback interface comprises:
determining a playback multi-speed corresponding to a swipe amplitude of a swipe operation in response to the swipe operation on the playback interface, and adjusting the playback multi-speed of the multimedia resource to the playback multi-speed corresponding to the swipe amplitude.

10. The method according to claim 9, wherein
the method further comprises:
displaying a plurality of multi-speed controls on the playback interface in the multi-speed mode, wherein the plurality of multi-speed controls correspond to different playback multi-speeds; and
said determining the playback multi-speed corresponding to the swipe amplitude of the swipe operation in response to the swipe operation on the playback interface, and adjusting the playback multi-speed of the multimedia resource to the playback multi-speed corresponding to the swipe amplitude comprise:
adjusting, in response to the swipe operation on the playback interface, the playback multi-speed of the multimedia resource to a playback multi-speed corresponding to a selected multi-speed control in the plurality of multi-speed controls based on the multi-speed control in the plurality of multi-speed controls selected by the swipe amplitude of the swipe operation.

11. The method according to claim 10, further comprising:
adjusting, in response to a trigger operation on any multi-speed control in the plurality of multi-speed controls, the playback multi-speed of the multimedia resource to a playback multi-speed corresponding to the any multi-speed control in the plurality of multi-speed controls.

12. The method according to claim 10, further comprising:
not displaying the plurality of multi-speed controls in the multi-speed mode in response to a duration from a current time to an operation time of the multi-speed adjust operation reaching a reference duration.

13. The method according to claim 9, wherein
the method further comprises:
displaying a multi-speed progress bar on the playback interface in the multi-speed mode, wherein two ends of the multi-speed progress bar respectively correspond to an upper threshold and a lower threshold of the playback multi-speed; and
said determining the playback multi-speed corresponding to the swipe amplitude of the swipe operation in response to the swipe operation on the playback interface, and adjusting the playback multi-speed of the multimedia resource to the playback multi-speed corresponding to the swipe amplitude comprise:
adjusting, in response to the swipe operation on the playback interface, the playback multi-speed of the multimedia resource to a playback multi-speed corresponding to a first multi-speed progress based on the first multi-speed progress determined by the swipe amplitude of the swipe operation.

14. The method according to claim 13, further comprising:
adjusting, in response to a drag operation on the multi-speed progress bar, the playback multi-speed of the multimedia resource to a playback multi-speed corresponding to a second multi-speed progress based on the second multi-speed progress determined by the drag operation.

15. The method according to claim 8, wherein the multi-speed adjust operation is a swipe operation to a third direction or a swipe operation to a fourth direction, wherein the swipe operation to the third direction and the swipe operation to the fourth direction correspond to different adjust directions of the playback multi-speed.

16. The method according to claim 8, further comprising:
performing a vibration prompt, wherein a vibration strength of the vibration prompt is positively correlated with the adjusted playback multi-speed.

17. The method according to claim 1, further comprising:
exiting the multi-speed mode in response to an end of the first multi-speed set operation.

18. The method according to claim 1, further comprising:
displaying a close control of the multi-speed mode on the playback interface in the multi-speed mode, wherein the close control is configured to enable exiting the multi-speed mode; and
exiting the multi-speed mode in response to a trigger operation on the close control; or
exiting the multi-speed mode in response to a trigger operation on the playback interface.

19. A terminal, comprising:
one or more processors;
a memory storing one or more instructions executable by the one or more processors; wherein
the one or more processors, when loading and executing the one or more instructions, are caused to:
play back the multimedia resource on a playback interface;
play back the multimedia resource in a multi-speed mode in response to a first multi-speed set operation on the playback interface, wherein the multi-speed mode corresponds to a reference playback multi-speed; and
continuously play back, in response to a progress adjust operation on the playback interface, the multimedia resource in the multi-speed mode using a playback progress corresponding to the progress adjust operation as a playback start point.

20. A non-transitory computer-readable storage medium storing one or more instructions, wherein the one or more instructions, when loaded and executed by a processor of a terminal, cause the terminal to:
play back the multimedia resource on a playback interface;
play back the multimedia resource in a multi-speed mode in response to a first multi-speed set operation on the playback interface, wherein the multi-speed mode corresponds to a reference playback multi-speed; and
continuously play back, in response to a progress adjust operation on the playback interface, the multimedia resource in the multi-speed mode using a playback progress corresponding to the progress adjust operation as a playback start point.
